(19) United States
(12) Patent Application Publication
(10) Pub. No.: US 2006/0045124 A1
(43) Pub. Date: Mar. 2, 2006

(54) Method and apparatus for providing access controls to communication services

(75) Inventors: Robert L. Dahlstrom, Jacksonville, FL (US); Kevin Bespolka, Vero Beach, FL (US); David DeWald, Jacksonville, FL (US)

Correspondence Address: FOLEY & LARDNER LLP, 150 EAST GILMAN STREET, P.O. BOX 1497, MADISON, WI, 53701-1497, US

(73) Assignee: Kidsnet, Inc.

(21) Appl. No.: 10/931,270

(22) Filed: Aug. 31, 2004

(51) Int. Cl. H04J 3/22; H04L 12/26; H04J 1/16; H04L 1/00; G06F 11/00; H04J 3/14

(52) U.S. Cl. 370/465

(57) ABSTRACT

A system, method, device, and control application are provided for controlling communication at a client device. A control application executing at the client device or on a network may be configured to send identification information for a user to a communication control web server; to receive access control information for the user from the communication control web server; to intercept a received communication sent to the user and/or to intercept a sent communication sent by the user; to determine if the received communication or the sent communication should be forwarded based on the access control information and a sender of the received communication or a recipient of the sent communication; and if the sender/recipient is found on an approved communication list, to send the communication to a client device networking layer. Other embodiments of the system include a client-portal architecture.

### FIELD OF THE INVENTION

The present invention is related to control applications for accessing communication services. More particularly, the present invention relates to a system for providing customized controls that allow, for example, a parent to determine who a child may receive e-mail from independently for each child or an employer to determine who an employee may instant message independently for each employee.

### BACKGROUND OF THE INVENTION

The Internet is a wide area network that connects hundreds of thousands of computers and smaller sub-networks world-wide. The World Wide Web (Web) is a subset of the computers that make up the Internet. Businesses, government bodies and entities, educational organizations, and individuals publish information to the Web thereby making the information accessible to others with access to the Web. Additionally, e-mail, the oldest Internet application, is used by more and more people as a means to communicate quickly for both personal and business purposes. More recently, instant messaging and chat rooms have evolved to provide real-time communication between individuals through the Internet.

Using the Internet, a user may access vast amounts of data and may communicate with a large number of people using e-mail, Instant Messaging (IM), and chat rooms. Not all of the data and the communications, however, should be accessed by all Internet users. Many websites contain what some users would consider violent, obscene, pornographic, crude, or discriminatory subject matter. Additionally, some Internet users inadvertently may communicate with individuals unknown to them that do not have the user's best interest at heart either through e-mail, IM, or chat rooms. For example, sexual predators have used chat rooms to meet children and, later, to lure them out of their homes or schools. E-mail has been used as a method for spreading viruses and for disseminating spam. IM can be similarly misused. Also, some individuals spend a large segment of time using various communication applications that may result in inattention to work or to school work. As a result, parents and employers may find it necessary to supervise their children's or employee's access to the Internet.

Thus, there is a need for a method and a system of controlling communication at a client device that eliminates the need for the parent or the employer to personally supervise an individual's access to communication applications. Further, there is a need for a communication control system that has a fast response time, does not create unnecessary processing delays, and maintains security through the use of centrally maintained controls that avoid the possibility of corrupting or of negating the access controls. Additionally, there is a need for a system that selectively blocks any communication application executing at the client device or that is accessed using an Internet website.

### SUMMARY OF THE INVENTION

An exemplary embodiment of the invention relates to a method for controlling communication at a client device. The method includes, but is not limited to, sending identification information for a user from a client device to a communication control web server using a network; at the client device, receiving access control information for the user from the communication control web server using the network; at the client device, intercepting a received communication sent to the user; at the client device, comparing a communication control parameter of each of one or more communication types to a communication type identifier of the received communication; at the client device, selecting an access setting and an approved sender list of the one or more communication type that matches the communication type identifier of the received communication; at the client device, if the selected access setting allows the user to receive the communication, comparing an approved sender identifier for each approved sender on the selected approved sender list to the sender identifier of the received communication; and at the client device, if the sender identifier is found on the selected approved sender list, sending the received communication to a client device networking layer. The access control information is selected based on the identification information. The access control information includes, but is not limited to, a communication control parameter, an access setting, and an approved sender list for the one or more communication type, the approved sender list including an approved sender identifier for each approved sender on the approved sender list. The received communication includes, but is not limited to, a sender identifier and a communication type identifier.

Another exemplary embodiment of the invention relates to a computer program product for controlling communication at a client device. The computer program product includes, but is not limited to, computer code configured to send identification information for a user to a communication control web server using a network; to receive access control information for the user from the communication control web server using the network and based on the identification information; to intercept a received communication sent to the user; to compare a communication control parameter of each of one or more communication types to a communication type identifier of the received communication; to select an access setting and an approved sender list of the one or more communication type that matches the communication type identifier of the received communication; if the selected access setting allows the user to receive the communication, to compare the approved sender identifier for each approved sender on the selected approved sender list to the sender identifier of the received communication; and if the sender identifier is found on the selected approved sender list, to send the received communication to a client device networking layer. The access control information is selected based on the identification information. The access control information includes, but is not limited to, a communication control parameter, an access setting, and an approved sender list for the one or more communication type, the approved sender list including an approved sender identifier for each approved sender on the approved sender list. The received communication includes, but is not limited to, a sender identifier and a communication type identifier.

Still another exemplary embodiment of the invention relates to a client device having controlled communication with other devices on a network. The client device includes, but is not limited to, a communication interface, a control application, a memory, and a processor. The communication interface is configured to send identification information for a user to a communication control web server and to receive access control information for the user from the communication control web server based on the identification information, wherein the access control information comprises a communication control parameter, an access setting, and an approved sender list for one or more communication types. The control application includes, but is not limited to, computer code configured to intercept a received communication sent to the user, wherein the received communication includes a sender identifier and a communication type identifier; to compare the communication control parameter of each of the one or more communication types to the communication type identifier of the received communication; to select the access setting and the approved sender list of the one or more communication type that matches the communication type identifier of the received communication; if the selected access setting allows the user to receive the communication, to compare the approved sender identifier for each approved sender on the selected approved sender list to the sender identifier of the received communication; and if the sender identifier is found on the selected approved sender list, to send the received communication to a client device networking layer. The memory is configured to store the control application. The processor is coupled to the memory and is configured to execute the control application.

Still another exemplary embodiment of the invention relates to a system for controlling communication at a client device. The system includes, but is not limited to, a communication control web server and a client device. The communication control web server communicates with a network. The client device includes, but is not limited to, a communication interface, a control application, a memory, and a processor. The communication interface is capable of communication with the network and is configured to send identification information for a user to a communication control web server and to receive access control information for the user from the communication control web server based on the identification information, wherein the access control information comprises a communication control parameter, an access setting, and an approved sender list for one or more communication types. The control application includes, but is not limited to, computer code configured to intercept a received communication sent to the user, wherein the received communication includes a sender identifier and a communication type identifier; to compare the communication control parameter of each of the one or more communication types to the communication type identifier of the received communication; to select the access setting and the approved sender list of the one or more communication type that matches the communication type identifier of the received communication; if the selected access setting allows the user to receive the communication, to compare the approved sender identifier for each approved sender on the selected approved sender list to the sender identifier of the received communication; and if the sender identifier is found on the selected approved sender list, to send the received communication to a client device networking layer. The memory is configured to store the control application. The processor is coupled to the memory and is configured to execute the control application.

Another exemplary embodiment of the invention relates to a method for controlling communication at a client device. The method includes, but is not limited to, sending identification information for a user from a client device to a communication control web server using a network; receiving access control information for the user from the communication control web server at the client device based on the identification information and using the network, wherein the access control information comprises a communication control parameter and an access setting for one or more communication types; at the client device, intercepting an Internet access request initiated by an application used at the client device by the user, wherein the Internet access request includes a uniform resource locator (URL); sending the URL to the communication control web server from the client device; at the client device, receiving a URL category of content from the communication control web server; at the client device, comparing the URL category of content to the communication control parameter of the one or more communication types; at the client device, selecting the access setting for the communication control parameter that matches the URL category of content; and at the client device, if the selected access setting allows access to the URL, sending the Internet access request to a client device networking layer.

Another exemplary embodiment of the invention relates to a computer program product for controlling communication at a client device. The computer program product includes, but is not limited to, computer code configured to send identification information for a user to a communication control web server using a network; to receive access control information for the user from the communication control web server based on the identification information and using the network, wherein the access control information comprises a communication control parameter and an access setting for one or more communication types; to intercept an Internet access request initiated by an application used at the client device by the user, wherein the Internet access request includes a uniform resource locator (URL); to send the URL to the communication control web server; to receive a URL category of content from the communication control web server; to compare the URL category of content to the communication control parameter of the one or more communication types; to select the access setting for the communication control parameter that matches the URL category of content; and if the selected access setting allows access to the URL, to send the Internet access request to a client device networking layer.

Still another exemplary embodiment of the invention relates to a client device having controlled communication with other devices on a network. The client device includes, but is not limited to, a communication interface, a control application, a memory, and a processor. The communication interface is configured to send identification information for a user to a communication control web server; to receive access control information for the user from the communication control web server based on the identification information, wherein the access control information comprises a communication control parameter and an access setting for one or more communication types; to send a uniform resource locator (URL) to the communication control web server; and to receive a URL category of content from the communication control web server. The control application includes, but is not limited to, computer code configured to intercept an Internet access request initiated by an application used at the client device by the user, wherein the Internet access request includes the URL; to compare the URL category of content to the communication control parameter of the one or more communication types; to select the access setting for the communication control parameter that matches the URL category of content; and if the selected access setting allows access to the URL, to send the Internet access request to a client device networking layer. The memory is configured to store the control application. The processor is coupled to the memory and is configured to execute the control application.

Still another exemplary embodiment of the invention relates to a system for controlling communication at a client device. The system includes, but is not limited to, a communication control web server and a client device. The communication control web server communicates with a network. The client device includes, but is not limited to, a communication interface, a control application, a memory, and a processor. The communication interface is capable of communication with the network and is configured to send identification information for a user to the communication control web server; to receive access control information for the user from the communication control web server based on the identification information, wherein the access control information comprises a communication control parameter and an access setting for one or more communication types; to send a uniform resource locator (URL) to the communication control web server; and to receive a URL category of content from the communication control web server. The control application includes, but is not limited to, computer code configured to intercept an Internet access request initiated by an application used at the client device by the user, wherein the Internet access request includes the URL; to compare the URL category of content to the communication control parameter of the one or more communication types; to select the access setting for the communication control parameter that matches the URL category of content; and to if the selected access setting allows access to the URL, send the Internet access request to a client device networking layer. The memory is configured to store the control application. The processor is coupled to the memory and is configured to execute the control application.

Another exemplary embodiment of the invention relates to a method for controlling communication through a portal based communication service. The method includes, but is not limited to, authenticating a user of a client device at a portal accessible using a network; if the user is authenticated, retrieving an access setting for a communication application from a database accessible by the portal, wherein the access setting indicates if the user may use the communication application; if the user may use the communication application, receiving a communication from a sender at the communication application, wherein the communication application comprises an approved communication list maintained by an administrator; searching the approved communication list for the sender of the received communication; and if the sender is found in the approved communication list, presenting the received communication to the user with the communication application.

Another exemplary embodiment of the invention relates to a computer program product for controlling communication through a portal based communication service. The computer program product includes, but is not limited to, computer code configured to provide a user interface for a communication application after authentication of a user at a portal and after a determination that the user may access the communication application, wherein the determination is made using an access setting for the user stored at the portal; to maintain an approved communication list accessible by an administrator; to receive a communication to the user from a sender; to search the approved communication list for the sender; and if the sender is found in the approved communication list, to present the received communication to the user in the user interface.

Still another exemplary embodiment of the invention relates to portal having controlled communication with other devices on a network. The portal includes, but is not limited to, a communication interface, a communication application, a memory, and a processor. The communication interface is configured to receive information from a client device and to receive a communication to a user from a sender. The communication application includes, but is not limited to, computer code configured to provide a user interface at the client device after authentication of the user using the information and after a determination that the user may access the communication application, wherein the determination is made using an access setting for the user; to maintain an approved communication list accessible by an administrator; to search the approved communication list for the sender of the received communication; and, if the sender is found in the approved communication list, to present the received communication to the user in the user interface. The memory is configured to store the communication application. The processor is coupled to the memory and is configured to execute the communication application.

Still another exemplary embodiment of the invention relates to a system for controlling communication through a portal based communication service. The system includes, but is not limited to, a client device and a portal. The client device communicates with a network. The portal includes, but is not limited to, a communication interface, a communication application, a memory, and a processor. The communication interface is capable of communication with the network and is configured to, but is not limited to, receive information from a client device and to receive a communication to a user from a sender. The communication application includes, but is not limited to, computer code configured to provide a user interface at the client device after authentication of the user using the information and after a determination that the user may access the communication application, wherein the determination is made using an access setting for the user; to maintain an approved communication list accessible by an administrator; to search the approved communication list for the sender of the received communication; and, if the sender is found in the approved communication list, to present the received communication to the user in the user interface. The memory is configured to store the communication application. The processor is coupled to the memory and is configured to execute the communication application.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of the client-server architecture of a communication access control system in accordance with an exemplary embodiment.

FIG. 2 is an overview diagram of example system components of the communication access control system of FIG. 1.

FIG. 3 is a functional diagram of an example client device system component of the communication access control system of FIG. 1.

FIG. 4 is a functional diagram of an example server device system component of the communication access control system of FIG. 1.

FIG. 5 is a flow diagram of an account manager of the communication access control system of FIG. 1.

FIG. 6 depicts an example user interface of the account manager of FIG. 5.

FIG. 7 depicts an example user interface of the communicator registration function of FIG. 6.

FIG. 8 depicts an example user interface of the child account definition function of FIG. 6.

FIG. 9 is a functional flow diagram of operations performed in accordance with a first exemplary embodiment of the communication access control system of FIG. 1.

FIG. 10 is a functional flow diagram depicting continued operations performed in accordance with the first exemplary embodiment.

FIG. 11 is a functional flow diagram of operations performed in accordance with an exemplary embodiment.

FIG. 12 is a functional flow diagram of operations performed in accordance with a second exemplary embodiment of the communication access control system of FIG. 1.

FIG. 13 is an overview diagram of the client-portal architecture of a communication access control system in accordance with an exemplary embodiment.

FIG. 14 is a functional diagram of an example client device system component of the communication access control system of FIG. 13.

FIG. 15 is a functional diagram of an example portal device system component of the communication access control system of FIG. 13.

FIG. 16 is a functional flow diagram of operations performed in accordance with an exemplary embodiment of the communication access control system of FIG. 13.

FIG. 17 is a functional flow diagram of continued operations performed in accordance with an exemplary embodiment.

FIG. 18 is a functional flow diagram of continued operations performed in accordance with an exemplary embodiment.

FIG. 19 depicts an example user interface of an instant messaging communication application.

FIG. 20 depicts a first set of menu options of the instant messaging communication application of FIG. 19.

FIG. 21 depicts a second set of menu options of the instant messaging communication application of FIG. 19.

FIG. 22 depicts a communication preparation user interface of the instant messaging communication application of FIG. 19.

FIG. 23 depicts a third set of menu options of the instant messaging communication application of FIG. 19.

### DETAILED DESCRIPTION OF THE PREFERRED EMBODIMENTS

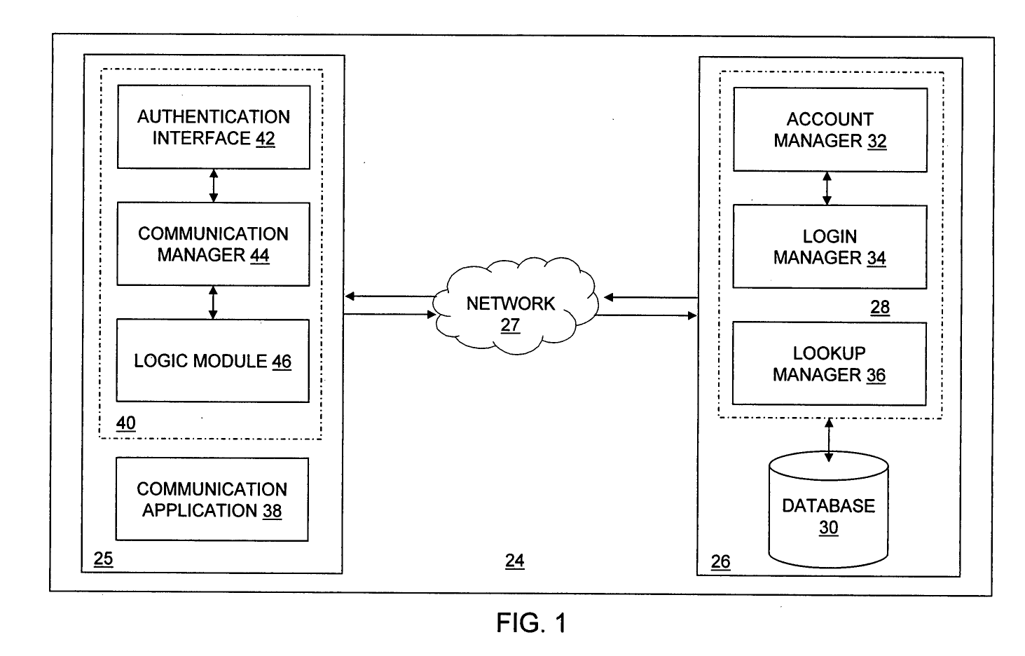

With reference to FIG. 1, the communication control system 24 is comprised of a client device 25 and a communication control web server 26 that interact using a network 27. The network 27 may include, but is not limited to, the Internet, and communicates information between the respective devices. The communication control web server 26 includes, but is not limited to, a web server application 28 and a database 30 that stores data accessible by the web server application 28. The functional processing of the web server application 28 includes, but is not limited to, an account manager 32, a login manager 34, and a lookup manager 36. The client device 25 includes, but is not limited to, a communication application 38 and a control application 40 that controls the access of a user of the client device 25 to the communication application 38. The functional processing of the control application 40 includes, but is not limited to, an authentication interface 42, a communication manager 44, and a logic module 46. The client device 25 modules generally will be located on a single device. The communication control web server 26 modules may be located on different devices that are connected to a common network such as a Local Area Network (LAN), a Wide Area Network (WAN), or the Internet. In an exemplary embodiment, information flow between the client device 25 and the communication control web server 26 is encrypted to maintain data security.

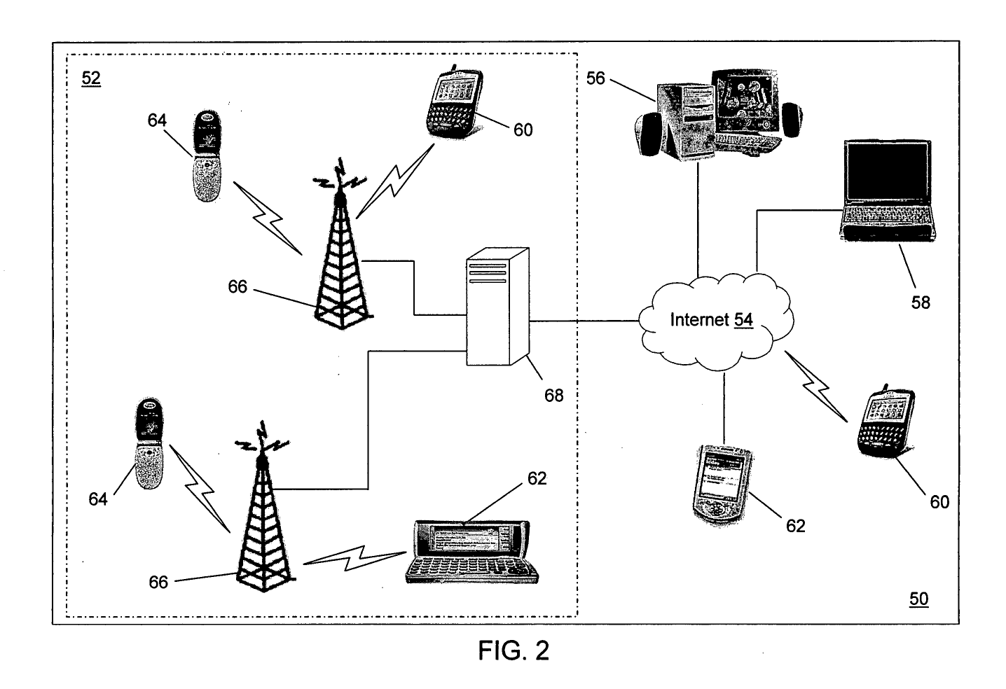

With reference to FIG. 2, the system 50 is comprised of multiple devices that can communicate through a network. The system 50 may comprise any combination of wired or wireless networks including, but not limited to, a cellular telephone network 52, a wireless LAN, a Bluetooth personal area network, an Ethernet LAN, a token ring LAN, a WAN, the Internet 54, etc. The system 50 may include both wired and wireless devices. For exemplification, the system 50 shown in FIG. 2 includes the cellular telephone network 52 and the Internet 54. Connectivity to the Internet 54 may include, but is not limited to, long range wireless connections, short range wireless connections, and various wired connections including, but not limited to, telephone lines, cable lines, power lines, etc.

The cellular telephone network 52 includes, but is not limited to, one or more devices, a base station 66 and a network server 68. In the cellular telephone network 52, the devices may send and receive signals through the base station 66. The network server 68 allows communication between the devices and another network. For example, the network server 68 may connect the devices with other devices through the Internet 54. The devices may include, but are not limited to, a desktop computer 56, a notebook computer 58, an Integrated Communication Device (ICD) 60, such as those manufactured by Blackberry, Inc., a Personal Data Assistant (PDA) 62, such as those manufactured by PALM, Inc., and/or a cellular telephone 64. The system 50 may include additional devices and devices of different types as well as any combination of devices. The functionalities described for the client device 25 and the communication control web server 26 may be implemented in one or more of the devices.

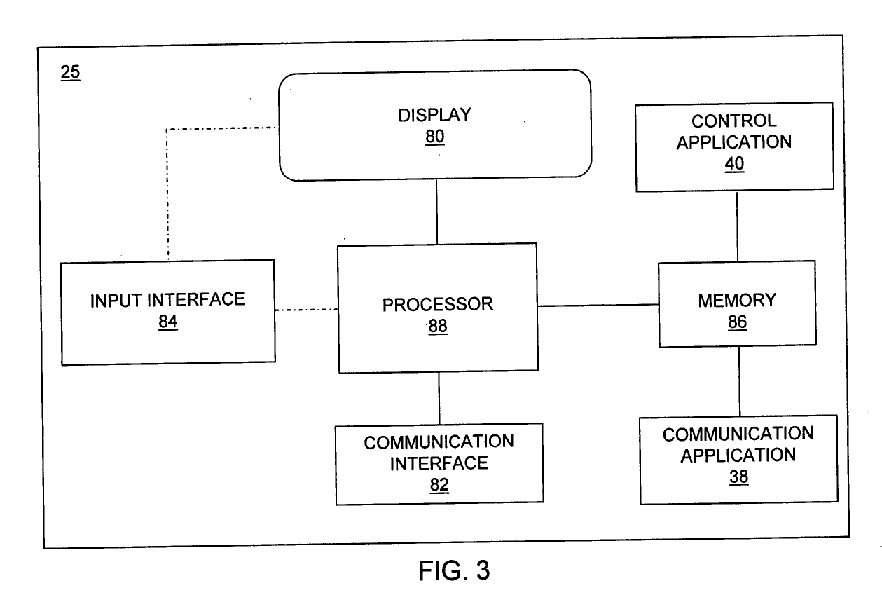

For exemplification, FIG. 3 shows a functional block diagram of the client device 25 that may be included in system 50 in an exemplary embodiment. The client device 25 includes a display 80, a communication interface 82, an input interface 84, a memory 86, a processor 88, the communication application 38, and the control application 40. The term “device” should be understood to include, without limitation, cellular telephones, PDAs, ICDs, computers of all form factors, etc. The client device 25 may or may not be mobile. Different and additional components may be incorporated into the client device 25. The client device 25 allows a user to connect to a network, such as the Internet 54, and to send and to receive communications from other devices connected to the network. The components of client device 25 may each be internal or external to the client device 25. The components may connect to each other using a number of different methods as known to those skilled in the art. Connections between the components of client device 25 may be other than or in addition to those shown in FIG. 3.

The display 80 presents information to the user of the client device 25 including, but not limited to, information from the communication application 38. The display may be, but is not limited to, a thin film transistor (TFT) display, a light emitting diode (LED) display, a Liquid Crystal Display (LCD), a Cathode Ray Tube (CRT) display, etc.

The communication interface 82 provides an interface for receiving and transmitting calls, messages, and/or any other information communicated across the network including, but not limited to, the communication of all message types including an instant message, an e-mail message, a short message, a multimedia message, and a Conversational Hypertext Access Technology (CHAT) message. Communications between the client device 25 and the network may be through one or more of the following connection methods, without limitation: an infrared communications link, a wireless communications link, a cellular network link, a physical serial connection, a physical parallel connection, a link established according to the Transmission Control Protocol/Internet Protocol (TCP/IP) and Standards, etc.

To access information or to communicate with people using the Internet or another network generally requires use of a variety of different protocols. Protocols commonly used include, but are not limited to, the HyperText Transfer Protocol (HTTP), the File Transfer Protocol (FTP), the Post Office Protocol (POP), the Simple Mail Transfer Protocol (SMTP), the Internet Message Access Protocol (IMAP), the Session Initiation Protocol (SIP), the Message Session Relay Protocol (MSRP), the Real Time Transport Protocol (RTTP), the Session Description Protocols (SDP), TCP/IP, the SIP for Instant Messaging and Presence Leveraging Extensions (SIMPLE), the extensible Messaging and Presence Protocol (XMPP), etc. For example, the Web consists of Web servers that respond to HTTP requests to access a web page. Each web page is identified by a Uniform Resource Locator (URL) that includes the location or Web address of the computer that contains the resource to be accessed in addition to the location of the resource on that computer. The resource may be a simple text file, a script, an image file, an audio file, a video file, an executable, a common gateway interface application, a Java applet, or any other file supported by HTTP.

An Internet or Web address, generally is composed of four parts: a protocol name, the location of a web server that provides the website information, a name identifying the organization or individual that maintains the web server, and a suffix that identifies the type of organization. For example, “.com” identifies a commercial organization, “.edu” identifies an educational institution, and “.gov” identifies a government organization. The protocol name specifies the protocol (i.e. HTTP, POP3, SMTP, FTP, SIP, SIMPLE) that defines the set of rules and standards to be applied when exchanging information between the web server that communicates the website information and a client computer that receives and displays the website information. The URL includes the Internet address and the resource location on the web server. The resource defines the web page presentation. A URL is a particular form of a Uniform Resource Identifier (URI). The URL uniquely specifies the location of a particular resource on the Internet as well as the mechanism used to access the resource in the form of the protocol. As such, the URL is divided into several segments.

Communications between the client device 25 and the network may use one or more of the communication protocols without limitation. Transferring content to and from the client device 25 may use one or more of these connection methods and communication protocols or any others known to those skilled in the art or to be developed in the future.

The input interface 84 provides an interface for receiving information from the user for entry into the client device 25. The input interface 84 may use various input technologies including, but not limited to, a keyboard, a pen and touch screen, a mouse, a track ball, a touch screen, a keypad, one or more buttons, etc. to allow the user to enter information into the client device 25 or to make selections from the client device 25. The input interface 84 may provide both an input and an output interface. For example, a touch screen display presents information to the user and allows the user to make selections from the display.

The memory 86 provides an electronic holding place for an operating system of the client device 25, the communication application 38, the control application 40, and/or other applications. The client device 25 may have a plurality of memory devices 86 that use the same or different memory technologies. Example memory technologies include, but are not limited to, Random Access Memory (RAM), Read Only Memory (ROM), flash memory, etc. Data in RAM is volatile meaning that it remains only as long as the client device 25 is turned on. When the client device 25 is turned off, RAM loses its data. The values stored in ROM are always there, whether the client device 25 is on or not. For this reason, it is called non-volatile memory. Flash memory is a type of constantly-powered non-volatile memory that can be erased and reprogrammed in units of memory called blocks. A variety of different storage media may be used for each memory technology. For example, a Compact Disk (CD), a Digital Video Disk (DVD), and a hard disk are all ROM media types.

The processor 88 executes instructions that cause the client device 25 to perform various functions. The instructions may be written using one or more programming languages, scripting languages, assembly languages, etc. Additionally, the instructions may be carried out by a special purpose computer, logic circuits, or hardware circuits. Thus, the processor 88 may be implemented in hardware, firmware, software, or any combination of these methods. The term “execution” refers to the process of running an application or program or the carrying out of the operation called for by an instruction. The processor 88 executes an application meaning that it performs the operations called for by that application in the form of a series of instructions. The processor 88 may retrieve an application from a non-volatile memory that is generally some form of ROM or flash memory and may copy the instructions in an executable form to a temporary memory that is generally some form of RAM. The processor 88, for example, may execute instructions embodied in the operating system of the client device 25, the communication application 38, and the control application 40. The client device 25 may include one or more processors 88.

The communication application 38 may communicate with one or more servers. For example, the servers may be mail servers, web servers, etc. The communication application 38 may respond to various protocol commands, may interpret the HyperText Markup Language (HTML) and other Internet programming languages including, but not limited to, Java™ and Perl, and may present a web page for viewing by the user. The communication application 38 may display or otherwise process messages. The communication application 38 may be a web browser as known to those skilled in the art.

Text messaging technologies include e-mail, Instant Messaging (IM), facsimile, short messaging, multimedia messaging, and CHAT messaging. Short messaging and multimedia messaging are hybrids of e-mail and IM. The Short Messaging Service (SMS) is a store and forward method of transmitting short messages to and from mobiles devices. SMS can also be used to transmit e-mail and IM messages. The Multimedia Messaging Service (MMS) transmits messages to and from mobile communication devices in a store-and-forward manner much like SMS, but MMS allows a combination of text, sounds, images, and video. Chat rooms generally located on the Internet provide real-time, broadcast text messaging between a group of individuals who have joined the room. E-mail, SMS, MMS, and IM may be accessed from a web site or used locally on the client device.

Although e-mail, SMS, and MMS are store and forward systems that utilize a gateway to pass messages from senders to recipients, there are differences between these text messaging technologies. The most obvious difference is the length and the complexity of the messages. E-mail allows the attachment of files, the imbedding of images, and allows the use of HTML. SMS messages generally are limited to text messages between 80 and 500 characters depending on the service provider. MMS messages allow sounds, images, and video in addition to text displays. Additionally, messages generated by SMS and by MMS are immediately delivered directly to the device; whereas, e-mail may not be immediately delivered directly to the device, but may be stored in mail servers and sent either periodically or when a user logs onto the e-mail system. By comparison, an Instant Messaging Service (IMS) provides a user with access to a virtually real-time text conversation (or chat) with others who are simultaneously connected to the Internet. Mobile communication devices now support IM based on SMS technology giving users the ability to join public chat rooms, or create friends lists similar to IM software deployed on the Internet.

E-mail systems generally use the Internet to transmit communications. E-mail transmission, delivery, and processing employs a variety of protocols with SMTP, POP3, and IMAP being the most widely used. SMTP transfers e-mail between computers on the Internet and is used to send e-mail. A mail server receives the e-mail and handles it on behalf of the recipient. The e-mail is then read generally using either POP3 or IMAP. Using POP3, the e-mail is stored on the mail server until the recipient connects to the server when the e-mail is downloaded to the recipient's computer and removed from the mail server computer. Using IMAP, the e-mail is saved at the mail server. When the recipient connects to the mail server, the recipient views the e-mail sender and header. The recipient may then choose to download the e-mail or not. Thus, using IMAP, the mail server acts as a remote file server. An e-mail application is an example communication application 38 that uses underlying protocols to send and to receive e-mail messages and to present the communication information to the user in an easily understandable form. E-mail messages may include SMS messages and MMS messages.

An e-mail address is a URL. The e-mail URL includes the protocol, the mailbox, and the hostname of the computer that generally hosts the mail server. The mailbox and hostname are separated by an @ sign in the form “johndoe@acme.com” wherein “johndoe” is the mailbox name and “acme.com” identifies the hostname of the mail server.

An IM application is another example communication application 38 that uses underlying protocols to send and to receive IM messages and to present the communication information to the user in an easily understandable form. IM applications provide message and presence exchange in real time between two points on the Internet. IM systems generally provide one-to-one messaging, multi-user messaging, the ability to subscribe to a contact's presence, etc. An IM contact is a URL that may use any of a number of protocols including, but not limited to, SIP, SIMPLE, XMPP, MSRP, RTP, etc. Similar to an e-mail address, the IM contact URL identifies an individual.

SIP is a signaling protocol for Internet conferencing, telephony, presence, events notification, and IM. The protocol initiates call setup, routing, authentication and other features to send messages to endpoints within an IP domain. SIMPLE is an application of the SIP protocol for server-to-server and client-to-server interoperability in IM that was developed in an attempt to provide standardization in IM protocols. XMPP is an open, XML-based protocol for server-to-server near-real-time extensible instant messaging and presence. XMPP is a rival protocol to SIMPLE. The Jabber protocol is based on XMPP. Currently, different IM systems (i.e. AIM, ICQ, MSN, AOL, Yahoo) employ their own proprietary protocols and their own communication applications for execution at a client device. Some IM applications provide support for multiple IM systems (i.e. Trillian and Gaim). The Jabber protocol provides a mechanism for users to access multiple IM systems by registering with the gateway of a users choice in order to communicate with others that use that IM system. Because there are no common protocols for communication between IM systems, the user should have an account on the other system. The Jabber developed IM applications act as a “proxy” for the user on the other IM systems.

The control application 40 is an organized set of instructions that, when executed, cause the client device 25 to behave in a predetermined manner. The control application 40 may be written using one or more programming languages, assembly languages, scripting languages, etc. For the control application 40 to execute, the application may be translated into a machine language that the processor 88 understands. The machine language version of the control application 40 is generally known as the executable and is the commercially available version of the control application 40. The user executes the control application 40 by selecting the control application 40 for launch. Alternatively, the control application 40 may always be executing at the client device 25 background as known to those skilled in the art. Launching the control application 40 generally entails retrieving the executable from a permanent memory device and copying the executable to a temporary memory device, generally some form of RAM. The permanent memory device may be, but is not limited to, a hard disk, a floppy disk, a CD-ROM, etc. The functionality provided by the control application 40 will be discussed in more detail below.

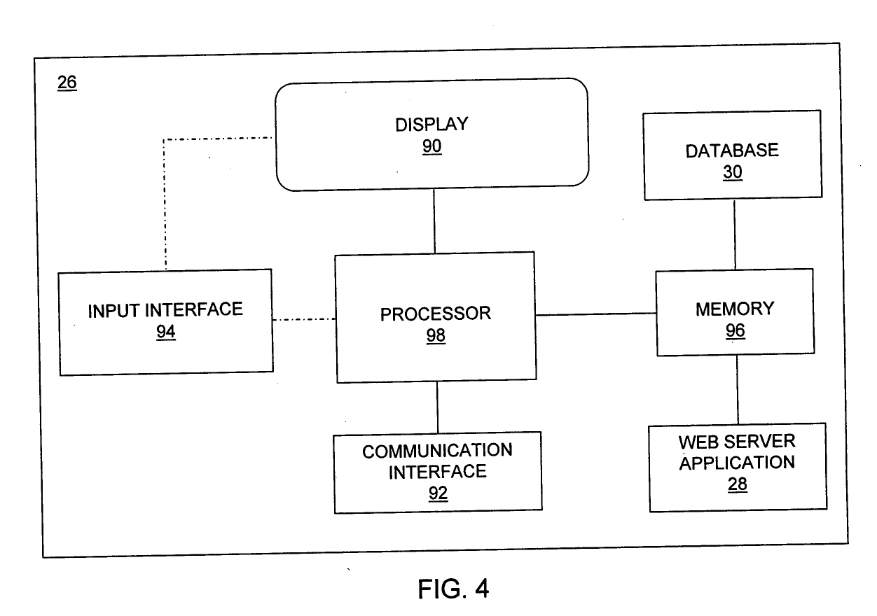

For exemplification, FIG. 4 shows a block diagram of communication control web server 26 that includes, but is not limited to, a display 90, a communication interface 92, an input interface 94, a memory 96, a processor 98, the web server application 28, and the database 30. Different and additional components may be incorporated into the communication control web server 26. The communication control web server 26 communicates website information to the client device 25. The components of communication control web server 26 may each be internal or external to the communication control web server 26. The components may connect using a number of different methods as known to those skilled in the art. Connections may be other than or in addition to those shown in FIG. 4.

The display 90 presents information to the user of the communication control web server 26 including, but not limited to, information from the web server application 28. The display may be, but is not limited to, a TFT display, an LED display, an LCD display, a CRT display, etc. The display 90 is optional.

The communication interface 92 provides an interface for receiving and transmitting calls, messages, and/or any other information communicated across a network including messages of all types. Communications between the communication control web server 26 and the network may be through one or more of the following connection methods, without limitation: an infrared communications link, a wireless communications link, a cellular network link, a physical serial connection, a physical parallel connection, a link established according to the TCP/IP Standards, etc. Communications between the communication control web server 26 and the network may use one or more of the following communication protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. Transferring content to and from the communication control web server 26 may use one or more of these connection methods and communication protocols or any others known to those skilled in the art or to be developed in the future.

The input interface 94 may provide an interface for receiving information from the user for entry into the communication control web server 26. The input interface 94 may use various input technologies including, but not limited to, a keyboard, a pen and touch screen, a mouse, a track ball, a touch screen, a keypad, one or more buttons, etc. to allow the user to enter information into the communication control web server 26 or to make selections from the communication control web server 26. The input interface 94 may provide both an input and an output interface. The input interface 94 is optional.

The memory 96 provides an electronic holding place for an operating system of the communication control web server 26, the web server application 28, the database 30, and/or other applications so that the information can be reached quickly by the processor 98. The communication control web server 26 may have a plurality of memory devices 96 that may use different memory technologies including, but not limited to, RAM, ROM, flash memory, etc.

The processor 98 executes instructions that cause the communication control web server 26 to perform various functions. The instructions may be written using one or more programming languages, scripting languages, assembly languages, etc. Additionally, the instructions may be carried out by a special purpose computer, logic circuits, or hardware circuits. Thus, the processor 98 may be implemented in hardware, firmware, software, or any combination of these methods. The processor 98 executes an application meaning that it performs the operations called for by that application in the form of a series of instructions. The processor 98 may retrieve an application from a non-volatile memory that is generally some form of ROM or flash memory and may copy the instructions in an executable form to a temporary memory that is generally some form of RAM. The processor 98 may execute instructions embodied in the web server application 28. The communication control web server 26 may include one or more processors 98.

The web server application 28 may communicate with the communication application 42 and/or the control application 40 at the client device 25. The web server application 28 may respond to any of the following communication protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. The web server application 28 may transmit one or more web pages to the client device 25 based on the user selection at the client device 25, the processing of the control application 40, and/or the processing of the communication application 42.

The database 30 may store web pages and information associated with the web pages. The web server application 28 interfaces with the database 30. The database 30 may utilize various database technologies as known to those skilled in the art including a simple file system and/or a system of tables. The database 30 also may use a variety of different formats as known to those skilled in the art. The communication control web server 26 may include a plurality of databases 64.

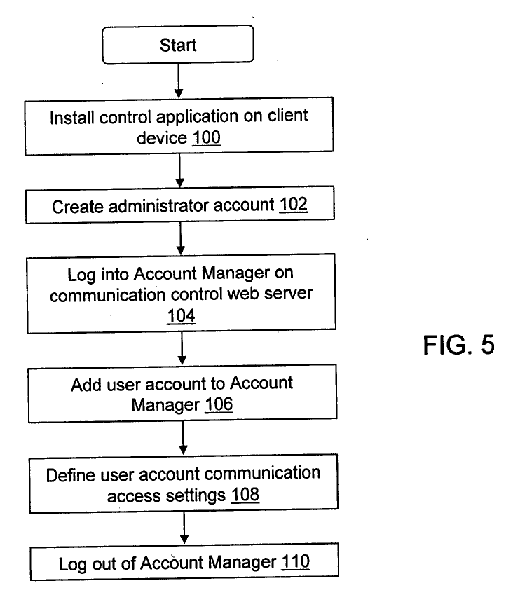

With reference to the exemplary embodiment of FIG. 5, the operations of the account manager 32 of the web server application 28 will be described below. FIG. 5 shows a functional flow diagram of processing operations performed by the account manager 32. Additional, fewer, or different operations may be performed, depending on the embodiment without deviating from the spirit of the invention. The account manager 32 configures the account either before or after the control application 40 is installed on the client device 25. FIG. 5 shows installation of the control application 40 at operation 100. As part of the installation process, the consumer may enter an Administrator identifier (Parent ID) and an Administrator password. At operation 102, the Administrator creates an Administrator account. The Administrator account information is communicated to the account manager 32 where it is stored in the database 30 of the communication control web server 26. As a result, after creating the Administrator account, the control application 40 may be installed on multiple computers using the same Administrator account information stored on the account manager 32 with no additional action required (i.e. the Administrator account is configured only once). Example parameters that may be used to create the Administrator account include, but are not limited to, an Administrator identifier, contact information such as an e-mail address, a name, an address, a city, a state, and a zip code.

At operation 104, the Administrator logs into the account manager 32 that is located on the communication control web server 26. The operation 104 of logging into the account manager 32 generally uses the Internet 54 to connect to the communication control web server 26. The Internet access may be achieved by opening a browser application and entering the URL for the homepage of the communication control web server 26 and selecting the link to the account manager 32. Additional methods for accessing the account manager 32 exist including, but not limited to, using a link selectable from the control application 40 and/or using a system that connects automatically after successful installation of the control application 40 on the client device 25.

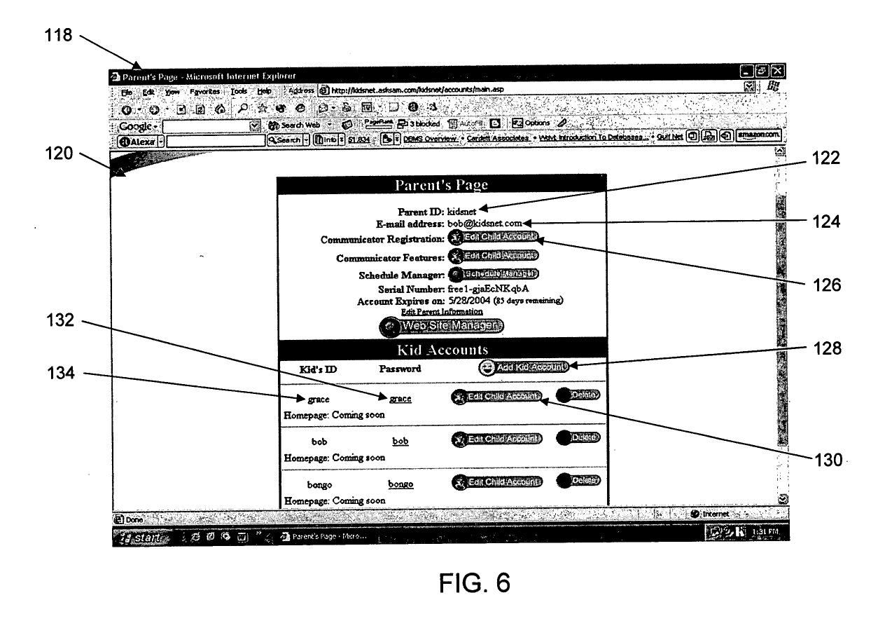

At operation 106, the Administrator creates one or more user accounts. FIG. 6 illustrates an exemplary embodiment of a user interface window 118 that may be displayed in a browser application executing at the client device 25 and that provides services for the account manager 32. The account management user interface window 118 includes, but is not limited to, a web page 120. The web page 120 includes, but is not limited to, an administrator identifier 122, an administrator e-mail address 124, a user account communication control button 126, an add user account button 128, an edit user account button 130, a user account identifier 132, and a user account password 134 for each user already added to the account manager 32. The administrator identifier 122 and the administrator e-mail address 124 may have been defined by the Administrator while creating the administrator account at operation 102. The add user account button 128 allows the Administrator to create the one or more user accounts of operation 106. When creating a user account, the Administrator may be prompted to enter the user account identifier 132 and/or the user account password 134 for the user account.

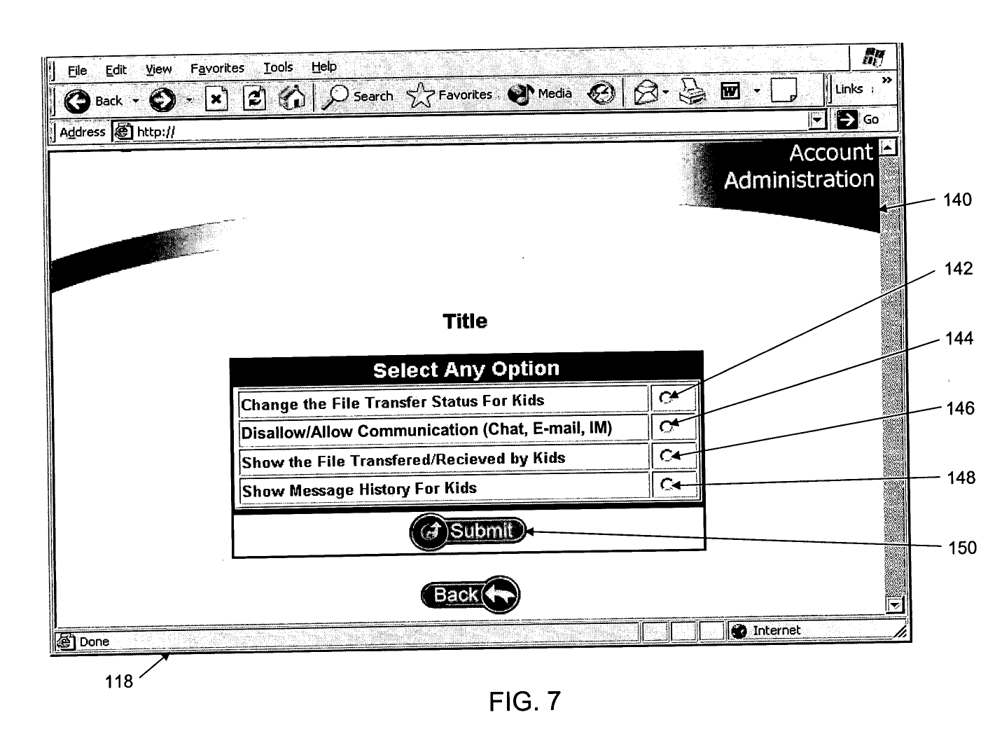

At operation 108, the Administrator defines the communication access settings for the user account. For example, FIG. 7 shows a group of settings that the Administrator may use to define the communication access settings for the user account. The web page 140 may have been displayed after the Administrator selected the user account communication control button 126. The web page 140 includes, but is not limited to, a file status button 142, a disallow/allow contacts button 144, a view files button 146, a message history button 148, and a submit button 150. The disallow/allow contacts button 144, in an exemplary embodiment, presents the current approved communication list to the Administrator. The Administrator may edit this list adding or deleting individuals. The list may be subdivided into an approved sender list and an approved recipient list to distinguish between those individuals that the user may receive communications from and those individuals that the user may send communications to. The approved communication list includes a sender/recipient identifier that identifies the sender/recipient of a communication. The approved communication list may include URLs that identify the sender/recipient in the approved communication list for e-mail contacts, IM contacts, and CHAT rooms. The message history button 148, in an exemplary embodiment, presents the communications received and/or sent by the user to the Administrator.

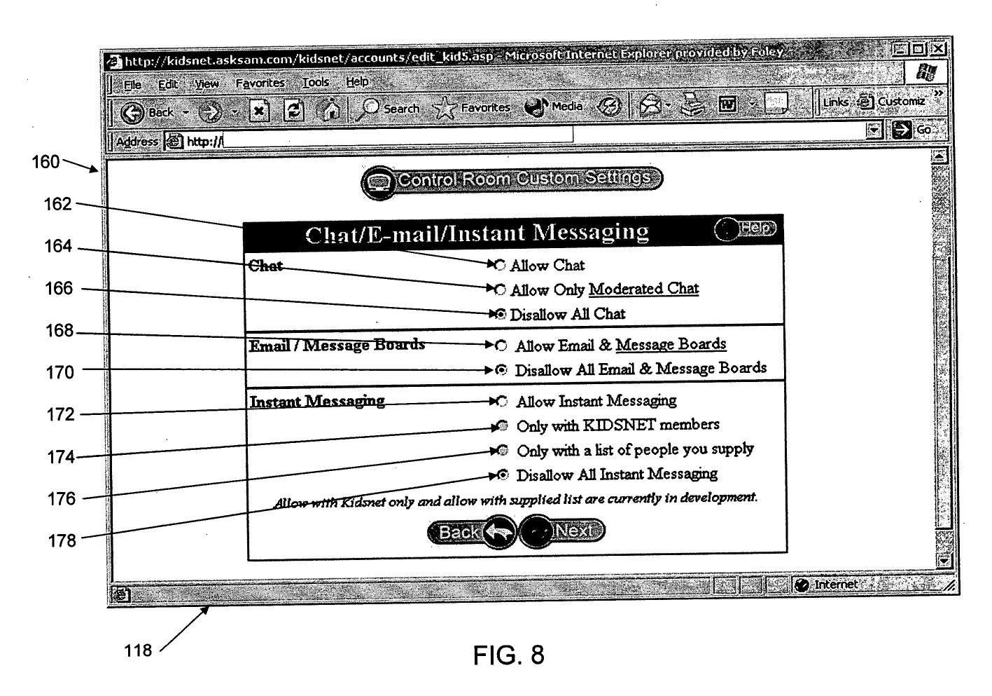

The Administrator selects the desired functional button 142, 144, 146, 148 and selects the submit button 150 to perform that function. For example, FIG. 8 shows a group of settings that the Administrator may use to define additional communication access settings for the user account. The web page 160 may have been displayed after the Administrator selected the disallow/allow contacts button 144. The web page 160 includes, but is not limited to, an allow CHAT button 162, an allow moderated CHAT button 164, a disallow CHAT button 166, an allow e-mail button 168, a disallow e-mail button 170, an allow IM button 172, an allow only IM network members button 174, an allow only the approved communication list button 176, and a disallow IM button 178. In an alternative embodiment, the Administrator may further specify that the user may communicate only with individuals on the approved communication list for both e-mail and IM. The Administrator may specify members of the approved communication list using a number of different methods as known to those skilled in the art. For example, the user may be allowed to e-mail any individual at a specific domain. Additionally, the Administrator may further specify that web based e-mail and/or IM may be allowed, but client device based e-mail and/or IM is not allowed or vice versa. After selecting the communication access settings for each user, the Administrator logs out at operation 110 of FIG. 5.

The account manager 32 may be implemented as a web based application. The login manager 34 may be implemented as executable code that interacts with the account manager 32 and the communication manager 44 of the control application 40. The lookup manager 36 may be implemented as executable code that interacts with the communication manager 44. The authentication interface 42 may be implemented as a software application that prompts a user for identification information that includes, but is not limited to, a name and a password. The authentication interface 42 transmits the identification information to the communication manager 44 or directly to the login manager 34 of the communication control web server 28. The communication manager 44 may be implemented as a Virtual Device Driver (VxD) that interfaces directly with the computer communications layer and networking communications such as the TCP/IP stack or driver. The logic module 46 may be implemented as a Dynamic Link Library (DLL) or executable code that determines whether or not access to a communication should be allowed.

In an exemplary embodiment, the authentication interface 42 prompts a user for identification information that may include a name and a password. The authentication interface 42 sends the identification information to the communication manager 44. The communication manager 44 sends the identification information to the login manager 34 located on the communication control web server 26 using network messaging protocols as related previously through the communication interfaces 82, 92. After the login manager 34 verifies the identification information, the login manager 34 selects the communication access settings stored in database 30 previously defined for that user, typically by the Administrator that may be a parent or an employer. The login manager 34 sends the communication access settings to the communication manager 44 again using the network 27 and the network messaging protocols.

When the user of the client device 25 sends or receives a communication, the communication manager 44 intercepts the communication. The communication manager 44 intercepts all network traffic and determines if the message should be sent to the client networking layer for processing by the appropriate communication application 38. The determination may be based, for example, on the URL, the communication protocol contained within the URL, a TCP/IP port number, a named pipe, and/or a sender or a recipient of the communication. In an exemplary embodiment, the communication manager 44 extracts the URL from the communication and sends the URL to the logic module 46. The logic module 46 determines if access to the URL is allowed or disallowed. If access to the URL is allowed, the logic module extracts the communication sender or recipient identifier from the URL. The logic module compares the extracted sender/recipient identifier to each sender/recipient identifier on the approved communication list. Communication is allowed if the extracted sender/recipient identifier is found on the approved communication list. If communication to the sender or recipient is allowed, the communication is sent by the communication manager 44 to the computer networking layer or protocol to which the communication was routed.

In an exemplary embodiment, the communication manager 44 may send the URL to the lookup manager 36 located on the communication access control web server 26. The lookup manager 44 attempts to locate the URL in a master list of pre-evaluated websites that have been categorized based on the content of the website. If the URL is not found, the lookup manager 36 sends a message stating this fact to the communication manager 44. The lookup manager 36 sends a message that may include the URL category of content if the URL is found to the communication manager 44. The communication manager 44 sends the message to the logic module 46. If the URL is not found, access to the URL may be allowed by the logic module 46. Alternatively, the logic module 46 may not allow access if the URL is not found. If the URL is found, the logic module 46 compares the URL category of content to the communication control parameter for the user. If the logic module 46 determines the communication is allowed, the communication manager 44 sends the communication to the computer networking layer or protocol to which the communication was routed.

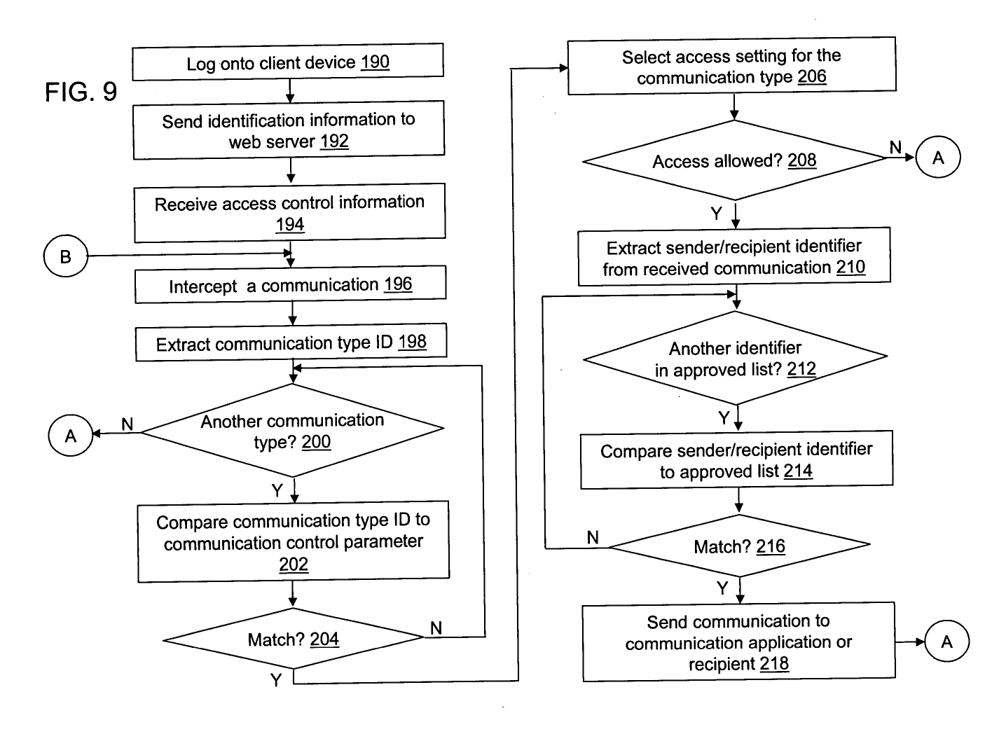

FIG. 9 shows a flow diagram of an exemplary execution process for the control application 40. After configuring the user account(s), the control application 40 execution may be initiated whenever a user of the client device 25 sends or receives a communication whether from a browser, an e-mail application, an IM application, or any other communication application 38 installed on the client device 25. The communication manager 44, for example, may be implemented as a VxD, an object linking and embedding custom control, a DLL, or as an executable. The communication manager 44 continuously monitors for a request to access the networking layer of the client device 25 for communicating with a network to which the client device 25 is connected, typically the Internet 54, but possibly a LAN, a PAN, a WAN, etc.

With reference to FIG. 9, the user logs onto the client device 25 at operation 190 using the authentication interface 42. At operation 192, the identification information for the user is sent to the login manager 34 of the communication control web server 26. The login manager 34 authenticates the user using the identification information and identifies the access control information for the user defined by the Administrator using the account manager 32 of the communication control web server 26. The access control information may include, but is not limited to, a communication control parameter, an access setting, and an approved communication list for one or more communication types. The approved communication list includes a sender/recipient identifier for each entry in the list. The approved communication list may be divided into an approved sender list and an approved recipient list. The communication control parameter may include, but is not limited to, a communication protocol, a communication port number, and/or a named pipe. The access setting may be a numerical or a textual indicator of the access allowed/disallowed/partially allowed to the communication type. The communication type may be a numerical or a textual indicator of the communication type that may include, but is not limited to, an instant message, an e-mail message, a short message, a multimedia message, and/or a CHAT message.

In an alternative embodiment, the access control information may further include a disapproved communication list for one or more communication types. The disapproved communication list includes a sender/recipient identifier for each entry in the list. Communication with members of the list is prohibited. Additionally, a specific message may be sent to these members whenever a communication is received that includes their sender identifier.

At operation 194, the control application receives the access control information from the communication control web server 26. The communication manager 44 intercepts a sent or received communication at operation 196. The communication manager 44 determines if the user has been identified by the communication control system 24. For example, the user may be identified using the operating system user ID, the network system ID, or other identification information. If the user has not been identified, the communication manager 44 sends a message to the authentication interface 42 to prompt the user to enter the identification information at operation 190. After entering the identification information, the user selects the “Login” button.

The communication manager 44 may encrypt the identification information. The login manager 34 decrypts the identification information and verifies that the account exists, that the password is correct, and that the account remains valid. If the login manager 34 determines that the account information is invalid, does not exist, or the password is incorrect, the login manager 34 may send a message to the communication manager 44 to inform the user that an error has occurred and to prompt the user for the identification information. The communication manager 44 may send a message to the authentication interface 42 to prompt the user to enter the identification information again. Thus, operations 190 and 192 are repeated until valid account information is entered. Additionally, operations 190, 192, and 194 may be performed before or after operation 196.

The authentication interface 42 determines if the user is the Administrator. If the user is determined to be the Administrator, the user is allowed full, unrestricted access to communications. If the user is determined to be other than the Administrator, the authentication interface 42 sends the identification information to the communication control web server 26 again at operation 192.

If the user is not the Administrator, the intercepted sent or received communication may be sent to the logic module 46. The logic module 46 extracts the communication type identifier from the URL of the communication, at operation 198. The communication type identifier may be, but is not limited to, the communication protocol, the communication port number, and/or the named pipe extracted from the URL of the communication. The logic module 46 compares the communication type identifier of the sent or received communication to the communication control parameter of the one or more communication types. For example, the decision at operation 200, determines if there is another communication type in the access control information. If there is another communication type, at operation 202, the logic module 46 compares the communication type identifier of the sent or received communication to the communication control parameter of the communication type currently being processed. If the decision at operation 204 does not find a match with the communication control parameter, processing continues at operation 200. If the decision at operation 204 does find a match, the logic module 46 selects the access setting for the matched communication type at operation 206.

The decision at operation 208 determines if the access setting indicates that access to the communication type is allowed. If access is allowed, at operation 210, the identifier of the sender or of the recipient (sender/recipient) of the communication is extracted from the communication URL. The logic module 46 compares the sender/recipient identifier of the communication with each sender/recipient on the approved communication list. Thus, the decision at operation 212 determines if there is another sender/recipient identifier in the approved communication list. If there is another sender/recipient identifier in the approved communication list, the logic module 46 compares the sender/recipient identifier from the approved communication list to the sender/recipient identifier extracted from the communication at operation 214. If the decision at operation 216 does not find a match between the sender/recipient identifiers, processing continues at operation 212. If the decision at operation 216 does find a match, the logic module 46 sends the communication at operation 218. If the client device 25 received the communication, the communication is sent to the client networking layer of the client device for processing at the appropriate communication application. If the client device 25 sends the communication, the communication is sent to the recipient of the communication.

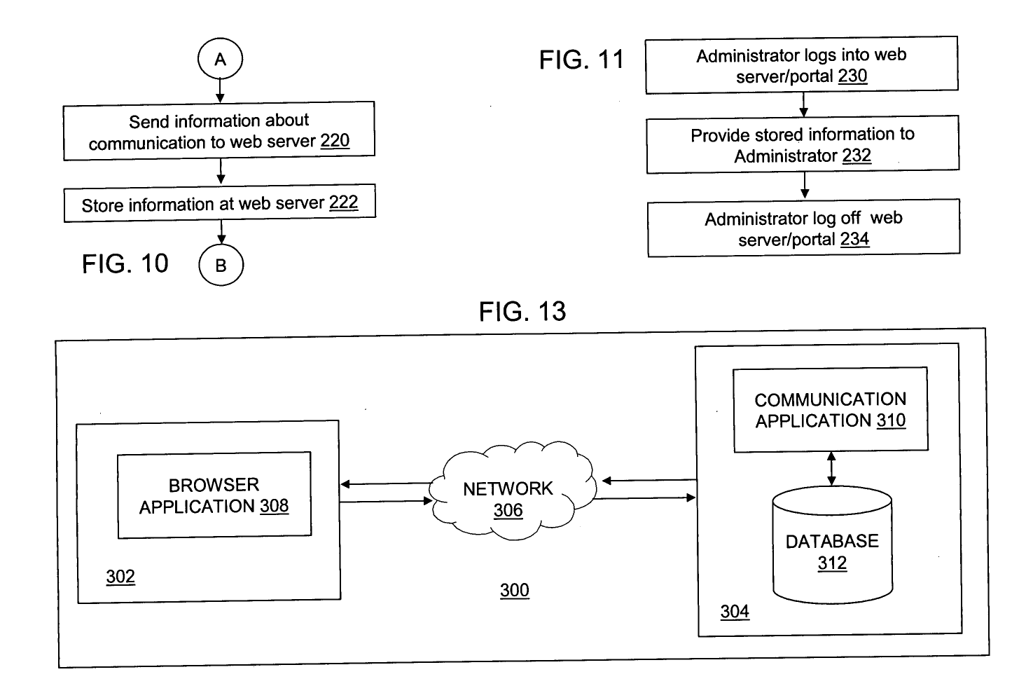

FIG. 10 depicts continued processing from the flow diagram of FIG. 9. At operation 220, information relative to the communication may be sent to the communication control web server. The information may include the text of the entire communication in addition to the time, the date, the sender/recipient identifier, any multimedia included in the communication, etc. The information is stored in the database 30 at the communication control web server 26 at operation 222. Processing then continues at operation 196 of FIG. 9.

FIG. 11 depicts processing that may occur in parallel with the processing depicted in FIGS. 9 and 10. At operation 230, the Administrator of the user account logs into the communication control web server 26. The information stored relative to the communication may be provided to the Administrator at operation 232. For example, as depicted in FIG. 7, the Administrator may select the message history button 148. In response to the selection, a web page may be displayed that includes a list of the communications received by the user. The Administrator may review each communication. At operation 234, the Administrator logs out from the communication control web server 26.

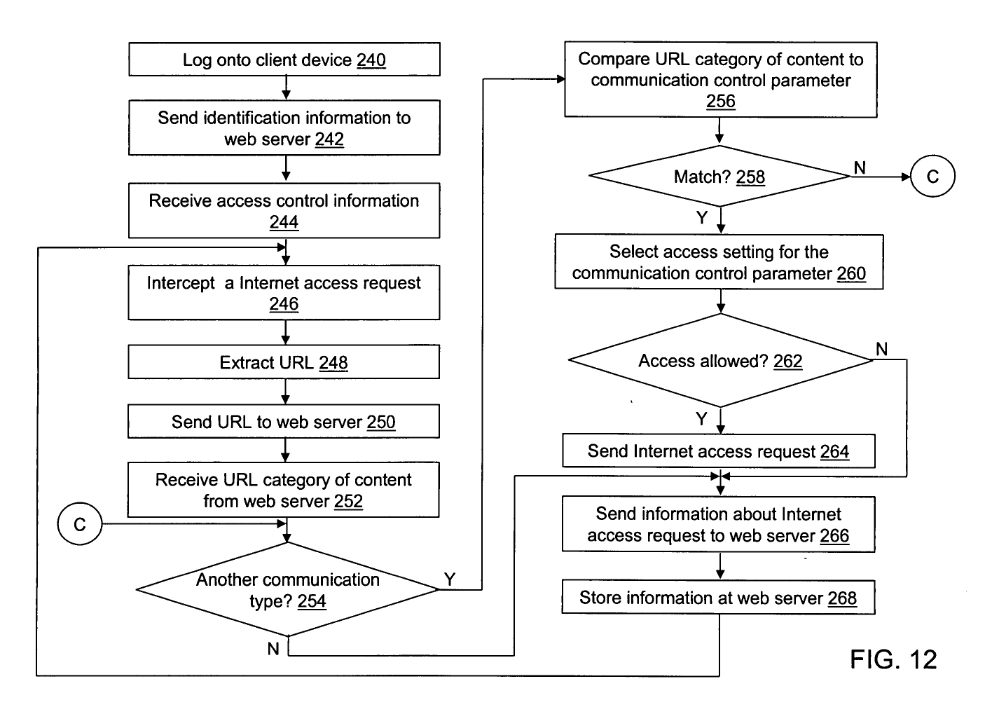

FIG. 12 depicts another embodiment of the invention. With reference to FIG. 12, the user logs onto the client device 25 at operation 240 using the authentication interface 42. At operation 242, the identification information for the user is sent to the login manager 34 of the communication control web server 26. The login manager 34 authenticates the user using the identification information and identifies the access control information for the user defined by the Administrator using the account manager 32 of the communication control web server 26. The access control information may include, but is not limited to, a communication control parameter, an access setting, and an approved communication list for one or more communication types. The approved communication list may be divided into an approved sender list and an approved recipient list. The approved communication list includes a sender/recipient identifier for each entry in the list. The communication control parameter may include, but is not limited to, a communication protocol, a communication port number, and/or a named pipe. The access setting may be a numerical or a textual indicator of the access allowed/disallowed/partially allowed to the communication type. The communication type may be a numerical or a textual indicator of the communication type that may include, but is not limited to, an instant message, an e-mail message, a short message, a multimedia message, and/or a CHAT message.

At operation 244, the control application receives the access control information from the communication control web server 26. The communication manager 44 intercepts an Internet access request at operation 246. The communication manager 44 determines if the user has been identified by the communication control system 24. If the user has not been identified, the communication manager 44 sends a message to the authentication interface 42 to prompt the user to enter the identification information at operation 240. After entering the identification information, the user selects the “Login” button.

The communication manager 44 may encrypt the identification information. The login manager 34 decrypts the identification information and verifies that the account exists, that the password is correct, and that the account remains valid. If the login manager 34 determines that the account information is invalid, does not exist, or the password is incorrect, the login manager 34 may send a message to the communication manager 44 to inform the user that an error has occurred and to prompt the user for the identification information. The communication manager 44 may send a message to the authentication interface 42 to prompt the user to enter the identification information again. Thus, operations 240 and 242 are repeated until valid account information is entered. Additionally, operations 240, 242, and 244 may be performed before or after operation 246.

The authentication interface 42 determines if the user is the Administrator. If the user is determined to be the Administrator, the user is allowed full, unrestricted access to communications. If the user is determined to be other than the Administrator, the authentication interface 42 sends the identification information to the communication control web server 26 again at operation 242.

If the user is not the Administrator, the intercepted Internet access request may be sent to the logic module 46. The logic module 46 extracts the URL of the Internet access request, at operation 248. At operation 250, the logic module 46 sends the URL to the communication manager 44 or directly to the communication control web server 26. The communication manager 44 sends the URL to the communication control web server 26. The communication control web server 26 identifies the category of content of the URL stored in the database 30. The communication control web server 26 sends the URL category of content to the client device 25. The client device 25 receives the URL category of content at operation 252. The logic module 46 compares the communication type provided at the URL to the communication control parameter of the one or more communication types. For example, the decision at operation 254, determines if there is another communication type in the access control information. If there is another communication type, at operation 256, the logic module 46 compares the URL category of content to the communication control parameter of the communication type currently being processed. If the decision at operation 258 does not find a match with the communication control parameter, processing continues at operation 254. If the decision at operation 258 does find a match, the logic module 46 selects the access setting for the matched communication type at operation 260.

The decision at operation 262 determines if the access setting indicates that access to the communication type is allowed. If access is allowed, at operation 264, the Internet access request is sent to the client networking layer of the client device 25.

At operation 266, information relative to the Internet access request may be sent to the communication control web server. The information may include the URL of the Internet access request, the time, the date, etc. The information is stored in the database 30 at the communication control web server 26 at operation 268. Processing then continues at operation 246.

FIG. 11 depicts processing that may occur in parallel with the processing depicted in FIG. 12. At operation 230, the Administrator of the user account logs into the communication control web server 26. The information stored relative to the communication may be provided to the Administrator at operation 232. For example, as depicted in FIG. 7, the Administrator may select the message history button 148. In response to the selection, a web page may be displayed that includes a list of the Internet access requests the user attempted to access. The Administrator may review each access request. At operation 234, the Administrator logs out from the communication control web server 26.

With reference to FIG. 13, the communication control system 300 is comprised of a client device 302 and a portal 304 that interact using a network 306. The network 306 may include, but is not limited to the Internet, and transmits information between the client device 302 and the portal 304. The client device 302 includes, but is not limited to, a browser application 308 that provides a user interface to the user when accessing the network. The portal 304 includes, but is not limited to, communication application 310 and a database 312 that stores data accessible by the communication application 310. The portal 304 modules may be located on different devices that are connected to a common network such as a LAN, a WAN, the Internet, etc. In an exemplary embodiment, information flow between the client device 302 and the portal 304 is encrypted to maintain data security.

Portals provide users with access to applications and other information as compared to, for example, a web based e-mail system that only provides access to e-mail. To access a portal, the user generally is first authenticated. The portal accesses the database to identify the applications and other information to make available to the user. As opposed to publicly accessible web sites, a portal may provide a user specific Web site that provides tools, reports, and services specifically designed for that individual. A portal effectively is software that manages the user access to multiple applications and information sources on the Internet or on an intranet. A Web browser application may provide the user interface to the portal that generally is accessible by entering a URL in the address bar of the browser application as known to those skilled in the art. Through the portal, the user may access, for example, IM and e-mail applications.

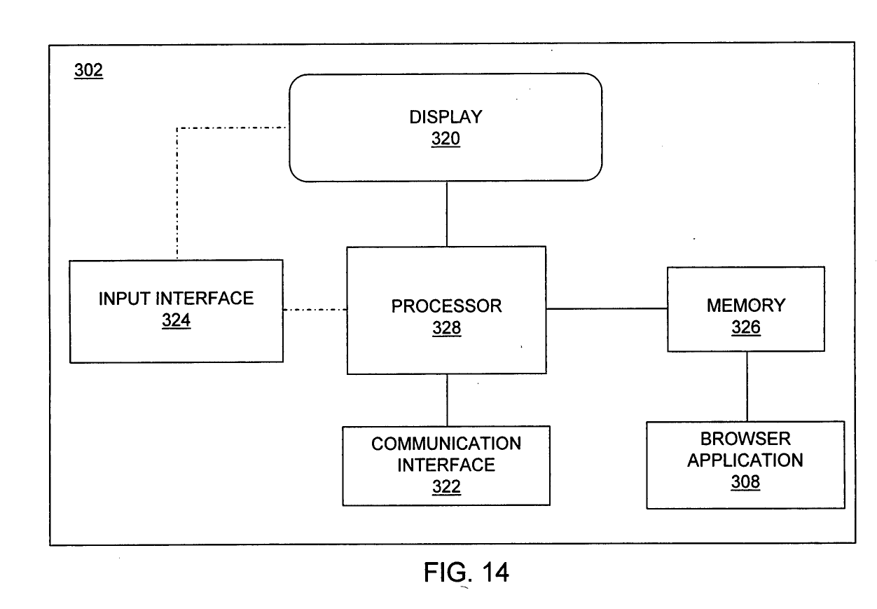

For exemplification, FIG. 14 shows a functional block diagram of the client device 302 that may be included in system 300 in an exemplary embodiment. The client device 302 includes a display 320, a communication interface 322, an input interface 324, a memory 326, a processor 328, and the browser application 308. The term “device” should be understood to include, without limitation, cellular telephones, PDAs, ICDs, computers of all form factors, etc. The client device 302 may or may not be mobile. Different and additional components may be incorporated into the client device 302. The client device 302 allows a user to connect to a network, such as the Internet 54, and to send and to receive communications from other devices connected to the network. The components of client device 302 may each be internal or external to the client device 302. The components may connect to each other using a number of different methods as known to those skilled in the art. Connections between the components of client device 302 may be other than or in addition to those shown in FIG. 14.

The display 320 presents information to the user of the client device 302 including, but not limited to, information from the browser application 308. The display may be, but is not limited to, a TFT display, a LED display, a LCD, a CRT display, etc.

The communication interface 322 provides an interface for receiving and transmitting calls, messages, and/or any other information communicated across the network 306 including, but not limited to, the communication of all message types including an instant message, an e-mail message, a short message, a multimedia message, and a CHAT message and the communication of resources that may be processed using HTTP. Communications between the client device 302 and the network may be through one or more of the following connection methods, without limitation: an infrared communications link, a wireless communications link, a cellular network link, a physical serial connection, a physical parallel connection, a link established according to the TCP/IP and Standards, etc.

Communications between the client device 302 and the network may use one or more communication protocols without limitation: HTTP, TCP/IP, FTP, POP, SMTP, IMAP, SIP, MSRP, RTTP, SDP, SIMPLE, XMPP, RTSP, RTP, UDP, multicast UDP, etc. Transferring content to and from the client device 302 may use one or more of these connection methods and communication protocols or any others known to those skilled in the art or to be developed in the future.

The input interface 324 provides an interface for receiving information from the user for entry into the client device 302. The input interface 324 may use various input technologies including, but not limited to, a keyboard, a pen and touch screen, a mouse, a track ball, a touch screen, a keypad, one or more buttons, etc. to allow the user to enter information into the client device 302 or to make selections from the client device 302. The input interface 324 may provide both an input and an output interface.

The memory 326 provides an electronic holding place for an operating system of the client device 302, the browser application 308, and/or other applications. The client device 302 may have a plurality of memory devices 326 that use the same or different memory technologies. Example memory technologies include, but are not limited to, RAM, ROM, flash memory, etc.

The processor 328 executes instructions that cause the client device 302 to perform various functions. The instructions may be written using one or more programming languages, scripting languages, assembly languages, etc. Additionally, the instructions may be carried out by a special purpose computer, logic circuits, or hardware circuits. Thus, the processor 328 may be implemented in hardware, firmware, software, or any combination of these methods. The processor 328 executes an application meaning that it performs the operations called for by that application in the form of a series of instructions. The processor 328 may retrieve an application from a non-volatile memory that is generally some form of ROM or flash memory and may copy the instructions in an executable form to a temporary memory that is generally some form of RAM. The processor 328, for example, may execute instructions embodied in the operating system of the client device 302 and the browser application 308. The client device 302 may include one or more processors 328.

The browser application 308 may communicate with one or more servers. For example, the servers may be mail servers, web servers, etc. The browser application 308 may respond to various protocol commands, may interpret HTML and other Internet programming languages including, but not limited to, Java™ and Perl, and may present a web page for viewing by the user. The browser application 308 may display or otherwise process messages.

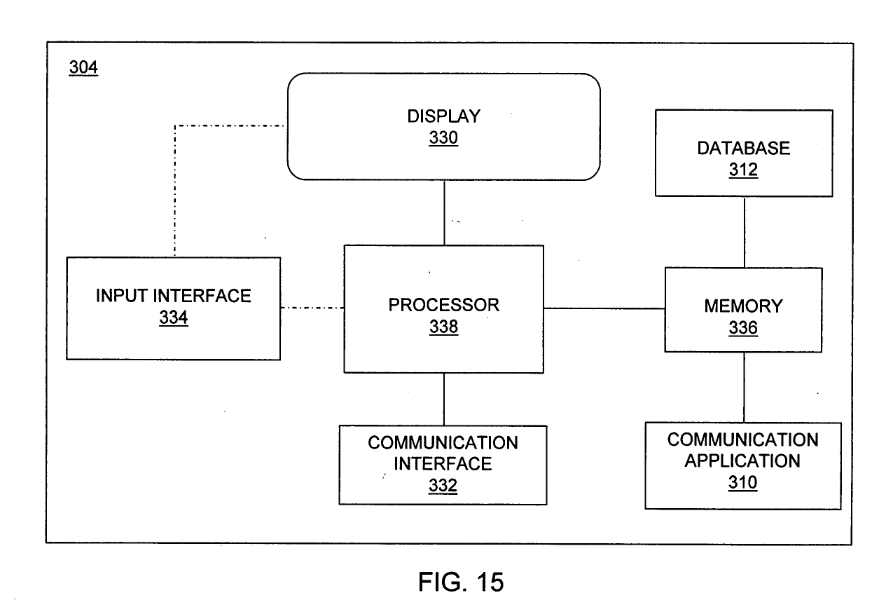

For exemplification, FIG. 15 shows a block diagram of portal 304 that includes, but is not limited to, a display 330, a communication interface 332, an input interface 334, a memory 336, a processor 338, the communication application 310, and the database 312. Different and additional components may be incorporated into the portal 304. The portal 304 communicates website information to the client device 302. The components of portal 304 may each be internal or external to the portal 304. The components may connect using a number of different methods as known to those skilled in the art. Connections may be other than or in addition to those shown in FIG. 15.

The display 330 presents information to the user of the portal 304 including, but not limited to, information from the communication application 310. The display may be, but is not limited to, a TFT display, an LED display, an LCD display, a CRT display, etc. The display 330 is optional.

The communication interface 332 provides an interface for receiving and transmitting calls, messages, and/or any other information communicated across a network including messages of all types and HTTP communications. Communications between the portal 304 and the network may be through one or more of the following connection methods, without limitation: an infrared communications link, a wireless communications link, a cellular network link, a physical serial connection, a physical parallel connection, a link established according to the TCP/IP Standards, etc. Communications between the portal 304 and the network may use one or more of the following communication protocols, without limitation: HTTP, TCP/IP, FTP, POP, SMTP, IMAP, SIP, MSRP, RTTP, SDP, SIMPLE, XMPP, RTSP, RTP, UDP, multicast UDP, etc. Transferring content to and from the portal 304 may use one or more of these connection methods and communication protocols or any others known to those skilled in the art or to be developed in the future.

The input interface 334 may provide an interface for receiving information from the user for entry into the portal 304. The input interface 334 may use various input technologies including, but not limited to, a keyboard, a pen and touch screen, a mouse, a track ball, a touch screen, a keypad, one or more buttons, etc. to allow the user to enter information into the portal 304 or to make selections from the portal 304. The input interface 334 may provide both an input and an output interface. The input interface 334 is optional.

The memory 336 provides an electronic holding place for an operating system of the portal 304, the communication application 310, the database 312, and/or other applications so that the information can be reached quickly by the processor 338. The portal 304 may have a plurality of memory devices 336 that may use different memory technologies including, but not limited to, RAM, ROM, flash memory, etc.

The processor 338 executes instructions that cause the portal 304 to perform various functions. The instructions may be written using one or more programming languages, scripting languages, assembly languages, etc. Additionally, the instructions may be carried out by a special purpose computer, logic circuits, or hardware circuits. Thus, the processor 338 may be implemented in hardware, firmware, software, or any combination of these methods. The processor 338 executes an application meaning that it performs the operations called for by that application in the form of a series of instructions. The processor 338 may retrieve an application from a non-volatile memory that is generally some form of ROM or flash memory and may copy the instructions in an executable form to a temporary memory that is generally some form of RAM. The processor 338 may execute instructions embodied in the communication application 310. The portal 304 may include one or more processors 338.

The communication application 310 may communicate with the browser application 308 at the client device 302. The communication application 310 may respond to communication protocols that include, but are not limited to, HTTP, TCP/IP, FTP, POP, SMTP, IMAP, SIP, MSRP, RTTP, SDP, SIMPLE, XMPP, RTSP, RTP, UDP, multicast UDP. The communication application 310 may transmit one or more web pages to the client device 302 based on the user selection at the client device 302 and/or the processing of the browser application 310. The portal 304 may include one or more communication applications 310. For example, an IM application, an e-mail application, and/or a chat room may be provided at the portal 304.

The database 312 may store web pages and information associated with the web pages. The communication application 310 interfaces with the database 312. The database 312 may utilize various database technologies as known to those skilled in the art including a simple file system and/or a system of tables. The database 312 also may use a variety of different formats as known to those skilled in the art. The portal 304 may include a plurality of databases 312.

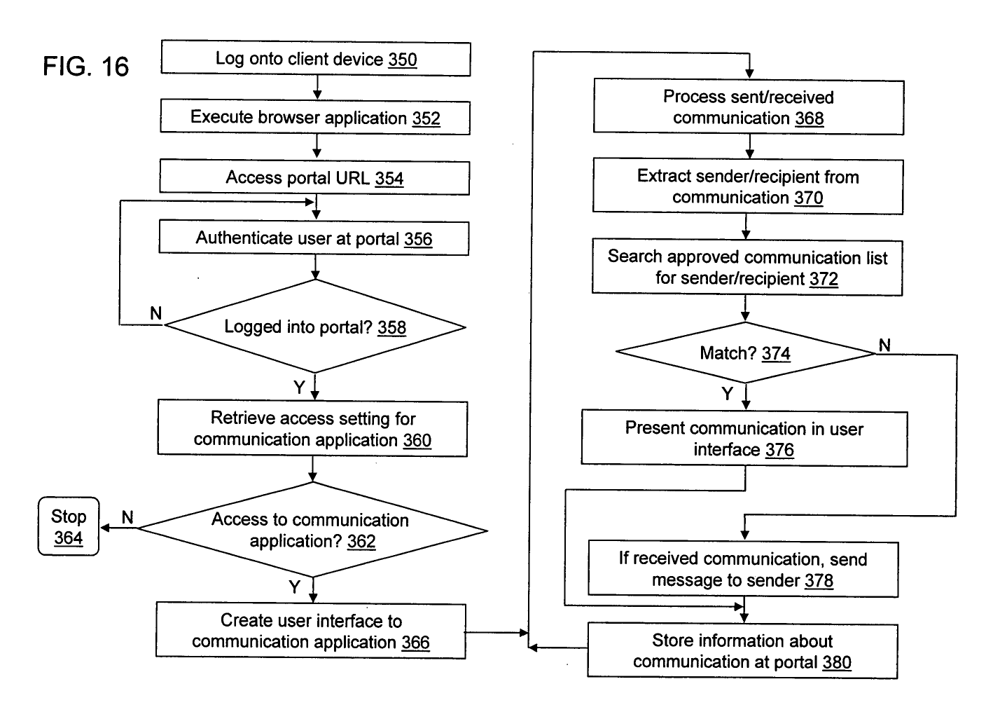

FIG. 16 depicts an embodiment of the invention that utilizes the client-portal architecture of FIG. 13. With reference to FIG. 16, the user logs onto the client device 302 at operation 350. At operation 352, the user executes the browser application 308 at the client device 302. At operation 354, the user accesses the portal 304 using the appropriate URL entered in the address bar of the browser application 308. The portal 304 authenticates the user as known to those skilled in the art at operation 356. If the portal 304 is unable to authenticate the user, at operation 358, processing continues at operation 356. After authentication, the user is logged into the portal 304. At operation 360, the portal 304 retrieves the access setting defined for the user relative to use of the communication application 310 at the portal 304. The user may have access to one or more communication applications 310. The decision at operation 362 determines if the user has access to any communication application 310. If not, processing stops. If the user has access to one or more communication application 310, a user interface to the one or more communication application 310 may be created at operation 366.

At operation 368, the communication application 310 processes a sent or a received communication. An identifier of the sender or the recipient of the communication is extracted at operation 370. The communication application 310 searches the approved communication list of senders and/or recipients using the identifier. If a match is found at operation 374, the communication is presented to the user in the user interface of the communication application 310 at operation 376. If a match is not found at operation 374 and the communication was received, the sender of the communication may be sent a message at operation 378. The message indicates to the sender that the message was not presented to the user. The message may include the e-mail address or IM address of the Administrator so that the sender may contact the Administrator to possibly be added to the approved communication list of the user. The approved communication list may be divided into an approved sender list and an approved recipient list. At operation 380, information relative to the communication may be stored at the portal 304 in the database 312, for example. Processing continues at operation 368.

FIG. 11 depicts processing that may occur in parallel with the processing depicted in FIG. 16. At operation 230, the Administrator of the user account logs into the portal 304. The information stored relative to the communication may be provided to the Administrator at operation 232. For example, as depicted in FIG. 7, the Administrator may select the message history button 148. In response to the selection, a web page may be displayed that includes a list of the Internet access requests the user attempted to access. The Administrator may review each access request. At operation 234, the Administrator logs out from the portal 304.

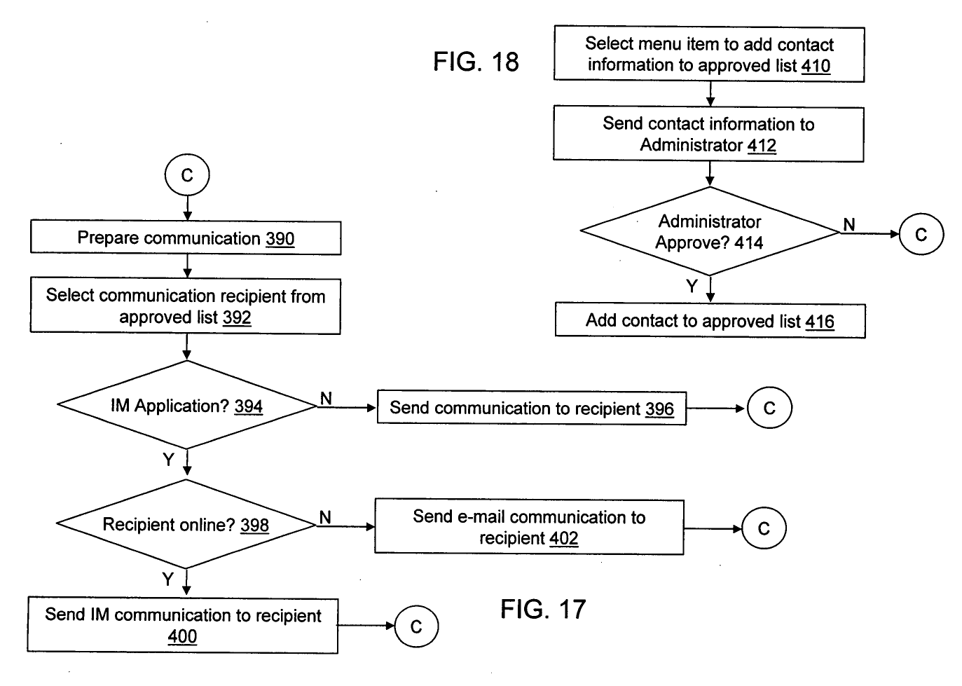

FIG. 17 depicts another aspect of the invention utilizing the client-portal architecture of FIG. 13. With reference to FIG. 17, the user prepares a communication using the communication application 310 at operation 390. At operation 392, the user selects the recipient of the communication from the approved communication list. The user may be restricted to the approved communication list for addressing the message. The decision at operation 394 determines if the communication application 310 is an IM application. If the communication application 310 is not an IM application, the communication is sent to the recipient at operation 396. Processing continues at operation 390 or alternatively may continue at operation 368 of FIG. 16 (not shown). If the communication application 310 is an IM application, the decision at operation 398 determines if the recipient of the instant message is currently on the network (online). If the user is online, the IM communication is sent to the recipient at operation 400. Processing continues at operation 390 or alternatively may continue at operation 368 of FIG. 16 (not shown). If the user is not online, the IM communication is sent to the recipient at operation 402 using an e-mail message. Processing continues at operation 390 or alternatively may continue at operation 368 of FIG. 16 (not shown).

FIG. 18 depicts another aspect of the invention utilizing the client-portal architecture of FIG. 13. With reference to FIG. 18, the user selects a menu item to add a contact to the approved communication list at operation 410. The user enters information for the contact into the user interface presented by selecting the menu item. The contact information is sent to the Administrator at operation 412. The decision at operation 414 determines if the user may add the contact to the approved communication list. If the Administrator approves the contact, the contact information is added to the approved communication list at operation 416. If the Administrator does not approve the contact, processing continues at operation 390 of FIG. 17 to allow the user to select a recipient from the approved communication list.

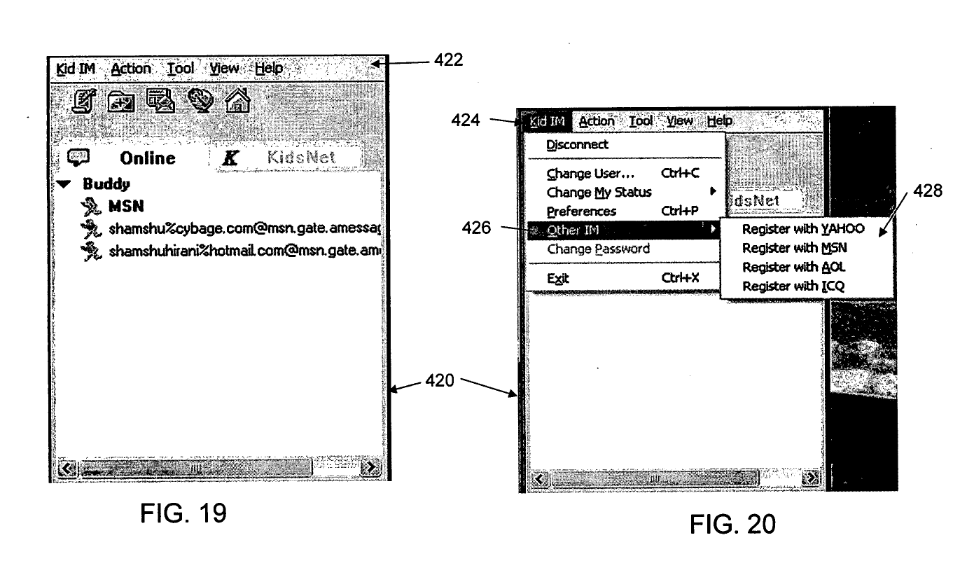

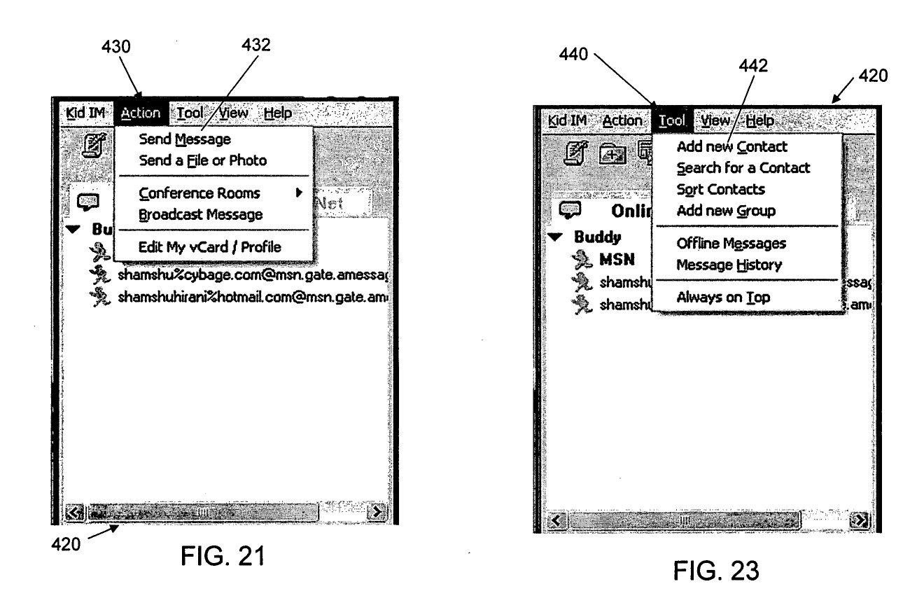

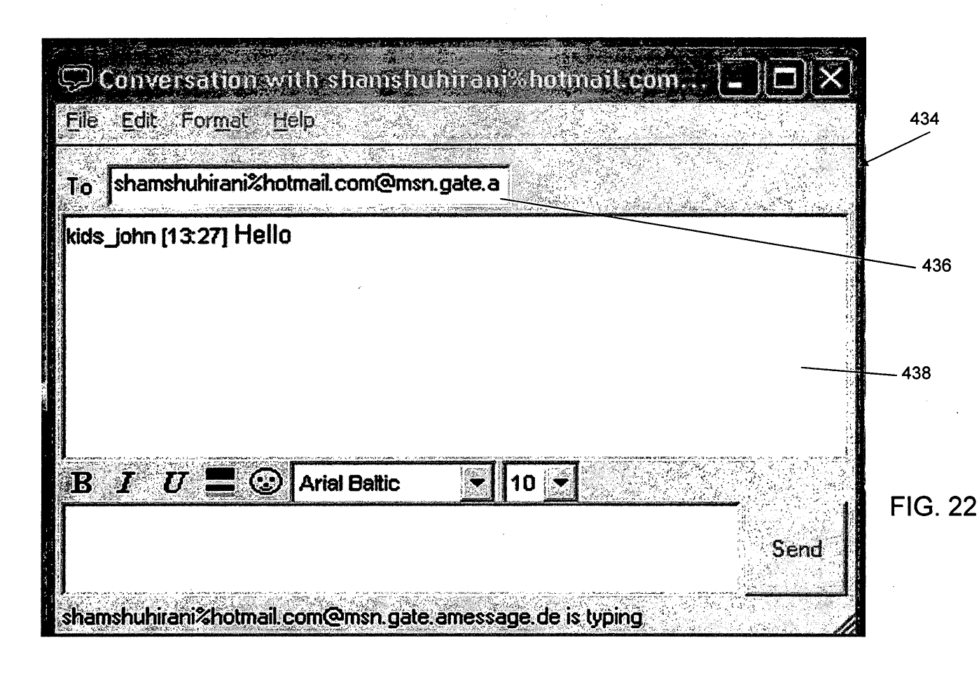

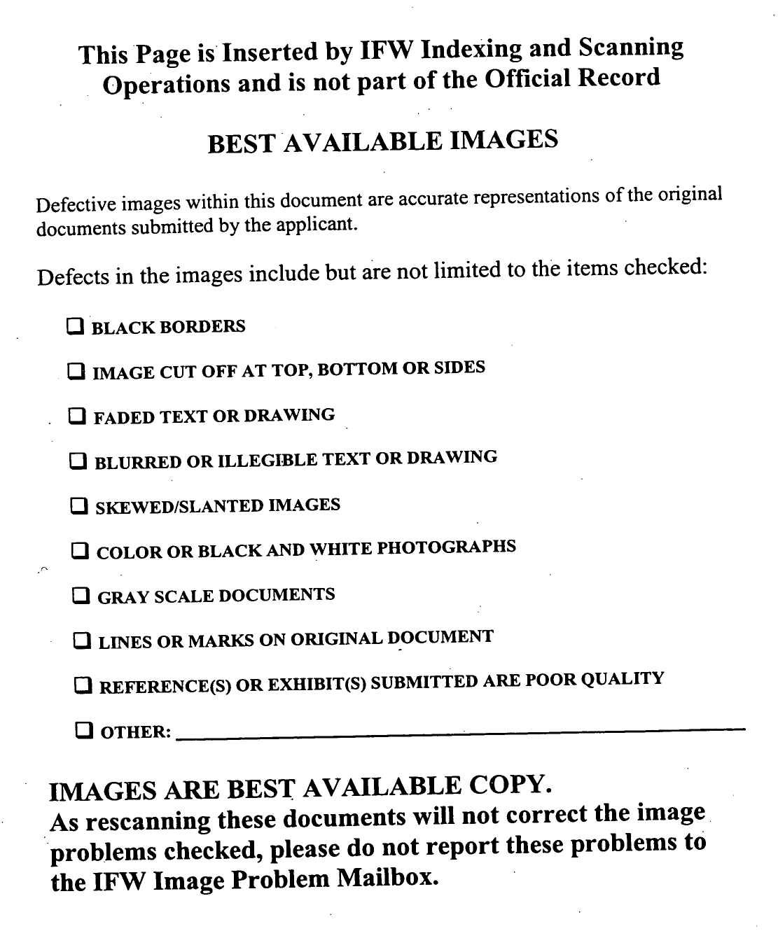

FIG. 19 depicts a user interface 420 for an IM application in an exemplary embodiment. The user interface 420 includes, but is not limited to, a menu bar 422. With reference to FIG. 20, the user may select a Kids IM menu item 424. When selected, the Kids IM menu item 424 displays a number of menu selections including, but not limited to, an other IM menu selection 426. When selected, the other IM menu selection 426 displays, in box 428, a plurality of instant messaging services with which the user may communicate. With reference to FIG. 21, the user may select an action menu item 430. When selected, the action menu item 430 displays a number of menu selections including, but not limited to, a send message menu selection 432. When selected, the user is presented, for example, with a communication user interface 434 shown in FIG. 22. The communication user interface 434 includes, but is not limited to, an address window 436 and a messaging window 438. With reference to FIG. 23, the user may select a tool menu item 440. When selected, the tool menu item 440 displays a number of menu selections including, but not limited to, an add new contact menu selection 442.

It is understood that the invention is not confined to the particular embodiments set forth herein as illustrative, but embraces all such modifications, combinations, and permutations as come within the scope of the following claims. The description above focused on an exemplary embodiment of the invention designed to operate in an Internet connected environment on a computer system executing a Microsoft® Windows based operating system. The present invention, however, is not limited to a particular operating environment. Those skilled in the art will recognize that the system and methods of the present invention may be advantageously operated on different platforms using different operating systems including, but not limited to, the Macintosh® operating system, UNIX® based operating systems, and/or LINUX based operating systems. Additionally, the functionality described may be implemented in a single executable or application or may be distributed among modules or managers that differ in number and distribution of functionality from those described herein without deviating from the spirit of the invention. Additionally, the order of execution of the functions may be changed without deviating from the spirit of the invention. Thus, the description of the exemplary embodiments is for purposes of illustration and not limitation.

What is claimed is:

1. A method for controlling communication at a client device, the method comprising:
sending identification information for a user from a client device to a communication control web server using a network;
at the client device, receiving access control information for the user from the communication control web server using the network, the access control information selected based on the identification information, wherein the access control information comprises a communication control parameter, an access setting, and an approved sender list for one or more communication type, the approved sender list including an approved sender identifier for each approved sender on the approved sender list;
at the client device, intercepting a received communication sent to the user, wherein the received communication includes a sender identifier and a communication type identifier;
at the client device, comparing the communication control parameter of each of the one or more communication types to the communication type identifier of the received communication;
at the client device, selecting the access setting and the approved sender list of the one or more communication type that matches the communication type identifier of the received communication;
at the client device, if the selected access setting allows the user to receive the communication, comparing the approved sender identifier for each approved sender on the selected approved sender list to the sender identifier of the received communication; and
at the client device, if the sender identifier is found on the selected approved sender list, sending the received communication to a client device networking layer.

2. The method of claim 1, further comprising sending information about the received communication to the communication control web server.

3. The method of claim 2, further comprising providing the stored information to an administrator.

4. The method of claim 1, wherein the access control information further comprises an approved recipient list for the one or more communication types, the approved recipient list including an approved recipient identifier for each approved recipient on the approved recipient list, and further comprising, at the client device, providing the approved recipient list to the user.

5. The method of claim 1, wherein the access control information further comprises an approved recipient list for the one or more communication types, the approved recipient list including an approved recipient identifier for each approved recipient on the approved recipient list, and further comprising:
at the client device, intercepting a sent communication sent by the user to a recipient, wherein the sent communication includes a recipient identifier and a communication type identifier;
at the client device, comparing the communication control parameter of each of the one or more communication types to the communication type identifier of the sent communication;
at the client device, selecting the access setting and the approved recipient list of the one or more communication type that matches the communication type identifier of the sent communication;
at the client device, if the selected access setting allows the user to send the sent communication, comparing the approved recipient identifier for each approved recipient on the selected approved recipient list to the recipient identifier of the sent communication; and
at the client device, if the recipient identifier is found on the approved recipient list, sending the sent communication.

6. The method of claim 5, further comprising sending information about the sent communication to the communication control web server and storing the information at the communication control web server.

7. The method of claim 6, further comprising providing the stored information to an administrator.

8. The method of claim 1, wherein the communication control parameter is selected from the group consisting of a communication protocol, a communication port number, and a named pipe, and further wherein the communication type identifier is selected from the group consisting of the communication protocol, a communication port number, and a named pipe.

9. The method of claim 1, wherein the communication type is selected from the group consisting of an instant message, an e-mail message, a short message, a multimedia message, and a conversational hypertext access technology message.

10. The method of claim 1, wherein the communication application is selected from the group consisting of an instant messaging application, an e-mail application, a short messaging application, a multimedia messaging application, and a conversational hypertext access technology messaging application.

11. The method of claim 1, wherein the communication application is an instant messaging application, and further wherein the instant messaging application provides communication with a plurality of instant messaging services.

12. A computer program product for controlling communication at a client device, the computer program product comprising:
computer code configured to:
send identification information for a user to a communication control web server using a network;
receive access control information for the user from the communication control web server using the network and based on the identification information, wherein the access control information comprises a communication control parameter, an access setting, and an approved sender list for one or more communication type, the approved sender list including an approved sender identifier for each approved sender on the approved sender list;
intercept a received communication sent to the user, wherein the received communication includes a sender identifier and a communication type identifier;
compare the communication control parameter of each of the one or more communication types to the communication type identifier of the received communication;
select the access setting and the approved sender list of the one or more communication type that matches the communication type identifier of the received communication;
if the selected access setting allows the user to receive the communication, compare the approved sender identifier for each approved sender on the selected approved sender list to the sender identifier of the received communication; and
if the sender identifier is found on the selected approved sender list, send the received communication to a client device networking layer.

13. A client device having controlled communication with other devices on a network, the client device comprising:
a communication interface, the communication interface configured to:
send identification information for a user to a communication control web server; and
receive access control information for the user from the communication control web server based on the identification information, wherein the access control information comprises a communication control parameter, an access setting, and an approved sender list for one or more communication types, the approved sender list including an approved sender identifier for each approved sender on the approved sender list;
a control application, the control application comprising computer code configured to:
intercept a received communication sent to the user, wherein the received communication includes a sender identifier and a communication type identifier;
compare the communication control parameter of each of the one or more communication types to the communication type identifier of the received communication;
select the access setting and the approved sender list of the one or more communication type that matches the communication type identifier of the received communication;
if the selected access setting allows the user to receive the communication, compare the approved sender identifier for each approved sender on the selected approved sender list to the sender identifier of the received communication; and
if the sender identifier is found on the selected approved sender list, send the received communication to a client device networking layer;
a memory, the memory configured to store the control application; and
a processor, the processor coupled to the memory and configured to execute the control application.

14. A system for controlling communication at a client device, the system comprising:
a communication control web server in communication with a network; and
a client device, the client device comprising:
a communication interface, the communication interface capable of communication with the network and configured to:
send identification information for a user to a communication control web server; and
receive access control information for the user from the communication control web server based on the identification information, wherein the access control information comprises a communication control parameter, an access setting, and an approved sender list for one or more communication types, the approved sender list including an approved sender identifier for each approved sender on the approved sender list;
a control application, the control application comprising computer code configured to:
intercept a received communication sent to the user, wherein the received communication includes a sender identifier and a communication type identifier;
compare the communication control parameter of each of the one or more communication types to the communication type identifier of the received communication;
select the access setting and the approved sender list of the one or more communication type that matches the communication type identifier of the received communication;
if the selected access setting allows the user to receive the communication, compare the approved sender identifier for each approved sender on the selected approved sender list to the sender identifier of the received communication; and
if the sender identifier is found on the selected approved sender list, send the received communication to a client device networking layer;
a memory, the memory configured to store the control application; and
a processor, the processor coupled to the memory and configured to execute the control application.

15. A method for controlling communication at a client device, the method comprising:
sending identification information for a user from a client device to a communication control web server using a network;
receiving access control information for the user from the communication control web server at the client device based on the identification information and using the network, wherein the access control information comprises a communication control parameter and an access setting for one or more communication types;
at the client device, intercepting an Internet access request initiated by an application used at the client device by the user, wherein the Internet access request includes a uniform resource locator (URL);
sending the URL to the communication control web server from the client device;
at the client device, receiving a URL category of content from the communication control web server;
at the client device, comparing the URL category of content to the communication control parameter of the one or more communication types;
at the client device, selecting the access setting for the communication control parameter that matches the URL category of content; and
at the client device, if the selected access setting allows access to the URL, sending the Internet access request to a client device networking layer.

16. The method of claim 15, further comprising sending information about the Internet access request to the communication control web server and storing the information at the communication control web server.

17. The method of claim 16, further comprising providing the stored information to an administrator.

18. The method of claim 15, wherein the communication control parameter is selected from the group consisting of an instant messaging application, an e-mail application, a short messaging application, a multimedia messaging application, and a conversational hypertext access technology messaging application.

19. The method of claim 15, wherein the URL category of content is selected from the group consisting of an instant messaging application, an e-mail application, a short messaging application, a multimedia messaging application, and a conversational hypertext access technology messaging application.

20. A computer program product for controlling communication at a client device, the computer program product comprising:
computer code configured to:
send identification information for a user to a communication control web server using a network;
receive access control information for the user from the communication control web server based on the identification information and using the network, wherein the access control information comprises a communication control parameter and an access setting for one or more communication types;
intercept an Internet access request initiated by an application used at the client device by the user, wherein the Internet access request includes a uniform resource locator (URL);
send the URL to the communication control web server;
receive a URL category of content from the communication control web server;
compare the URL category of content to the communication control parameter of the one or more communication types;
select the access setting for the communication control parameter that matches the URL category of content; and
if the selected access setting allows access to the URL, send the Internet access request to a client device networking layer.

21. A client device having controlled communication with other devices on a network, the client device comprising:
a communication interface, the communication interface configured to:
send identification information for a user to a communication control web server;
receive access control information for the user from the communication control web server based on the identification information, wherein the access control information comprises a communication control parameter and an access setting for one or more communication types;
send a uniform resource locator (URL) to the communication control web server; and
receive a URL category of content from the communication control web server;
a control application, the control application comprising computer code configured to:
intercept an Internet access request initiated by an application used at the client device by the user, wherein the Internet access request includes the URL;
compare the URL category of content to the communication control parameter of the one or more communication types;
select the access setting for the communication control parameter that matches the URL category of content; and
if the selected access setting allows access to the URL, send the Internet access request to a client device networking layer;
a memory, the memory configured to store the control application; and
a processor, the processor coupled to the memory and configured to execute the control application.

22. A system for controlling communication at a client device, the system comprising:
a communication control web server in communication with a network; and
a client device, the client device comprising:
a communication interface, the communication interface capable of communication with the network and configured to:
send identification information for a user to the communication control web server;
receive access control information for the user from the communication control web server based on the identification information, wherein the access control information comprises a communication control parameter and an access setting for one or more communication types;
send a uniform resource locator (URL) to the communication control web server; and
receive a URL category of content from the communication control web server;
a control application, the control application comprising computer code configured to:
intercept an Internet access request initiated by an application used at the client device by the user, wherein the Internet access request includes the URL;
compare the URL category of content to the communication control parameter of the one or more communication types;
select the access setting for the communication control parameter that matches the URL category of content; and
if the selected access setting allows access to the URL, send the Internet access request to a client device networking layer;
a memory, the memory configured to store the control application; and
a processor, the processor coupled to the memory and configured to execute the control application.

23. A method for controlling communication through a portal based communication service, the method comprising:
authenticating a user of a client device at a portal accessible using a network;
if the user is authenticated, retrieving an access setting for a communication application from a database accessible by the portal, wherein the access setting indicates if the user may use the communication application;
if the user may use the communication application, receiving a communication from a sender at the communication application, wherein the communication application comprises an approved communication list maintained by an administrator;
searching the approved communication list for the sender of the received communication; and
if the sender is found in the approved communication list, presenting the received communication to the user with the communication application.

24. The method of claim 23, further comprising storing information related to the received communication at the portal.

25. The method of claim 24, further comprising providing the stored information to an administrator.

26. The method of claim 23, further comprising:
if a communication is prepared by the user using the communication application, selecting a recipient for the prepared communication from the approved communication list; and
sending the prepared communication to the recipient using the communication application.

27. The method of claim 23, further comprising:
providing a user interface for the user to add contact information for a contact to the approved communication list;
sending the contact information to an administrator; and
adding the contact information to the approved communication list if the administrator approves the contact.

28. The method of claim 27, wherein the contact information comprises a contact name and a uniform resource locator.

29. The method of claim 23, further comprising, if the sender is not found in the approved communication list, sending a message to the sender indicating that the message was not presented to the user.

30. The method of claim 23, wherein the communication application is an instant messaging application.

31. The method of claim 30, further comprising sending an e-mail to a recipient of a communication prepared using the instant messaging application if the recipient is not available on the network.

32. The method of claim 23, wherein the communication application is selected from the group consisting of an instant messaging application, an e-mail application, a short messaging application, a multimedia messaging application, and a conversational hypertext access technology messaging application.

33. The method of claim 23, wherein the communication is selected from the group consisting of an instant message, an e-mail message, a short message, and a multimedia message.

34. A computer program product for controlling communication through a portal based communication service, the computer program product comprising:
computer code configured to:
provide a user interface for a communication application after authentication of a user at a portal and after a determination that the user may access the communication application, wherein the determination is made using an access setting for the user stored at the portal;
maintain an approved communication list accessible by an administrator;
receive a communication to the user from a sender;
search the approved communication list for the sender; and
if the sender is found in the approved communication list, present the received communication to the user in the user interface.

35. A portal having controlled communication with other devices on a network, the portal comprising:
a communication interface, the communication interface configured to:
receive information from a client device using a network; and
receive a communication to a user of the portal from a sender using the network;
a communication application, the communication application comprising computer code configured to:
provide a user interface at the client device after authentication of the user using the information and after a determination that the user may access the communication application, wherein the determination is made using an access setting for the user;
maintain an approved communication list accessible by an administrator;
search the approved communication list for the sender of the received communication; and
if the sender is found in the approved communication list, present the received communication to the user in the user interface;
a memory, the memory configured to store the communication application; and
a processor, the processor coupled to the memory and configured to execute the communication application.

36. A system for controlling communication through a portal based communication service, the system comprising:
a client device in communication with a network; and
a portal, the portal comprising:
a communication interface, the communication interface capable of communication with the network and configured to:
receive information from a client device; and
receive a communication to a user from a sender;
a communication application, the communication application comprising computer code configured to:
provide a user interface at the client device after authentication of the user using the information and after a determination that the user may access the communication application, wherein the determination is made using an access setting for the user;
maintain an approved communication list accessible by an administrator;
search the approved communication list for the sender of the received communication; and
if the sender is found in the approved communication list, present the received communication to the user in the user interface;
a memory, the memory configured to store the communication application; and
a processor, the processor coupled to the memory and configured to execute the communication application.
